(19) United States
(12) Patent Application Publication
(10) Pub. No.: US 2026/0187903 A1
(43) Pub. Date: Jul. 2, 2026

(54) CLUSTERING GEOMETRIC PRIMITIVES USING SPATIAL PROXIMITY AND CONNECTIVITY

(71) Applicant: Nvidia Corporation, Santa Clara, CA (US)

(72) Inventors: Pyarelal Knowles, Sunnyvale, CA (US); Tristan Lorach, Cupertino, CA (US); Karthik Vaidyanathan, Oakland, CA (US)

(21) Appl. No.: 19/006,828

(22) Filed: Dec. 31, 2024

(51) Int. Cl. G06T 15/06; G06T 17/20

(52) U.S. Cl. CPC G06T 15/06; G06T 17/20; G06T 2210/12; G06T 2210/21

(57) ABSTRACT

Approaches presented herein provide for the clustering of geometric primitives, such as triangular faces, of a mesh representation that is advantageous for downstream processing. In at least one embodiment, clustering can be performed based in part on the spatial locations of the geometric primitives, such as to minimize the surface area of bounding boxes around clustered primitives or minimize the overlap between bounding boxes. Other factors such as connectivity within, or across, clusters can also be considered. A cost function can be used that includes weighted combination of cost terms, where those cost terms can be selected based in part upon a type of downstream processing to be performed, or requirements/optimizations of hardware to perform the processing.

### BACKGROUND

In various applications—such as for rendering, light transport simulation (e.g., raytracing, path tracing, ray marching, etc.) or other types of image or video generation—there is a need to provide a representation of at least one object to be processed as part of the application. This representation can take the form of a geometric mesh, for example, along with one or more textures or other such assets. To improve efficiency, it can be beneficial to group together instances of the surface geometry—such as triangles or other geometric primitives—into clusters that can be processed together (or otherwise treated as single objects or primitives). In one example, the path of a ray may be traced that intersects a single cluster, and then hit testing would only need to be performed for the triangles within that cluster, instead of all possible triangles of a mesh to be used to render an image for a scene. Unfortunately, prior clustering approaches have not proven to provide optimal clustering, resulting in inefficiencies and, in some instances, artifacts in the rendered images.

### BRIEF DESCRIPTION OF THE DRAWINGS

Various embodiments in accordance with the present disclosure will be described with reference to the drawings, in which:

FIG. 1 illustrates an example geometric mesh representation with clusters of geometric faces, according to at least one embodiment;

FIG. 2 illustrates a view of an approach to splitting a set of geometric items using spatial location, according to at least one embodiment;

FIG. 3 illustrates components of an example system that can be used to determine clusters of items in a mesh representation, according to at least one embodiment;

FIG. 4 illustrates an example process that can be performed to perform clustering of elements in a mesh representation, according to at least one embodiment;

FIGS. 5A and 5B illustrate example approaches to determining and evaluating potential split plane positions, according to at least one embodiment;

FIG. 6 illustrates an example approach to determining clusters containing specific geometric items, according to at least one embodiment;

FIG. 7 illustrates images with, and without, degenerate results resulting from sub-optimal clustering, according to at least one embodiment;

FIG. 8 illustrates an example process that can be performed perform clustering of elements in a mesh representation based in part on connectivity, according to at least one embodiment;

FIGS. 9A and 9B illustrate components of an example content generation system, according to at least one embodiment;

FIG. 10 illustrates components of a distributed system that can be utilized to generate and provide image content, including generating mesh representations of one or more objects, according to at least one embodiment;

FIG. 11 illustrates an example data center system, according to at least one embodiment;

FIG. 12 illustrates a computer system, according to at least one embodiment;

FIG. 13 illustrates a computer system, according to at least one embodiment;

FIG. 14 illustrates at least portions of a graphics processor, according to one or more embodiments; and

FIG. 15 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), etc., systems for performing generative AI operations (e.g., using one or more language models, transformer models, etc.), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with various illustrative embodiments can facilitate the efficient processing of surface geometry, such as may be used with a light transport simulation-based rendering process. To improve efficiency, it can be beneficial to group together instances of surface geometry (e.g., triangles or other geometric primitives) into clusters, such that when the path of a ray is traced that only intersects a single cluster, for example, hit testing only needs to be performed for the triangles within that cluster, and not all possible triangles for a scene. Clusters can be set to be the same target size (or within a given range of sizes), where that size/range is determined in part by the number of triangles that can be stored concurrently in memory on a processing unit, such as a graphics processing unit (GPU). It can be beneficial for the triangles in a given cluster to be close to each other spatially, such as where bounding boxes around those clusters have a minimum size and are non-overlapping, or at most partially overlapping. In at least one embodiment, an expanded top-down bounding volume hierarchy (BVH) construction algorithm can be used where triangle centroids are used to split the grouping of triangles recursively, restricting the split position to produce leaves of a target size (or tight range of sizes). Clusters can be formed from items in leaf nodes, such that the terms “node” and “cluster” can be used nearly synonymously in this context (the term node is often used for a BVH hierarchy, but for clustering the hierarchy can be ignored). Each split (other than at the leaf nodes) can result in clusters that are multiples of the target cluster/group size. A selection can be made from among the possible split choices based in part upon a cost with respect to the surface area of bounding boxes around those clusters, such as to attempt to minimize an average/total surface area. In some embodiments, attempts can also be made to maximize cluster sizes by introducing a cost for under-filling, as well as to minimize the overlap between bounding boxes.

In at least one embodiment, further optimization can involve maximizing connectivity (or “adjacency”) within clusters. It is possible that an application may need, or at least benefit from, more control over how items are clustered, rather than just based on spatial locality. Approaches in accordance with at least one embodiment can use factors such as per-item connectivity and weights when clustering. Each item (e.g., triangle) can have a list of zero or more connected items, as well as a numerical weight for each connection. The sum of weights of internal connections within each cluster can be maximized or, equivalently, the sum of external connections minimized, in an attempt to identify a cut with a minimum cut cost. Such an approach has the advantage of providing variability in split plane location based, in part, upon the relevant costs. In at least one embodiment, a split cost value can be determined for each potential split plane position using a prefix sum scan. Such an approach may take advantage of connectivity tables that can be reconstructed for each axis to contain sorted-item-relative indices, with a minimum value being determined from among the various axes. In at least one embodiment, additional cut considerations can be used to avoid the introduction of artifacts due to the selection of cut locations that may produce a low cost but suboptimal results or artifacts downstream. This may include, for example, the use of a ratio cut that can divide relevant costs by the number of items on either side of a proposed cut location, or a normalize cut which can divide by the cumulative number of connections that each item has. These costs can then be summed with the surface area heuristic and one or more other costs (such as at least some of those disclosed herein) to select an optimal clustering or cut location for each of a number of iterations of a clustering process.

Variations of this and other such functionality can be used as well within the scope of the various embodiments as would be apparent to one of ordinary skill in the art in light of the teachings and suggestions contained herein.

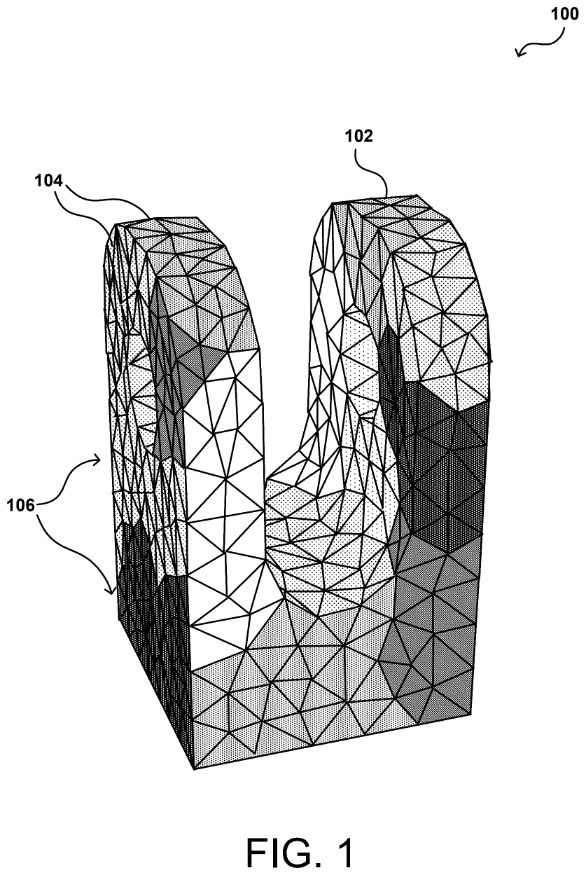

FIG. 1 illustrates a perspective view 100 of an example mesh representation 102 that can be generated and/or used in accordance with various embodiments. A three-dimensional (3D) object can be represented by a set of points in 3D space, such as in a Cartesian coordinate system. A mesh representation 102 of that object can be generated by using edges to connect pairs of these points, or “vertices,” where an edge between two vertices will then run approximately along the surface of the object (rather than connecting vertices that would result in the edges running through the interior of the object or across gaps in the object, which would not result in an accurate shape representation). A geometric mesh can include a plurality of geometric items (or elements, primitives, etc.), such as in the form of triangles or triangular faces 104 as illustrated in FIG. 1, formed by three edges between vertices. The faces of such a mesh representation 102, when taken in aggregate, can provide an approximation of the surface and/or shape of the corresponding 3D object. Smaller faces can provide a more accurate representation, but the increase in number of faces needed can increase the amount of resources needed to generate, store, and use the mesh data, so there is typically a balance between surface accuracy and data volume storage when determining the number of faces or vertices to be used to represent an object in a mesh, as well as the ranges of possible distances between vertices and other such factors. Triangular meshes are often used in rendering engines to render views of digital objects when combined with at least one texture or other visual element or aspect.

Existing raytracing application programming interfaces (APIs) are often based around an application providing all the geometry up front, or providing a mesh that can be used to build a bounding volume hierarchy (BVH) or other acceleration structure that the hardware can trace. This information is obtained or generated, then stored into local memory to allow tracing to be performed by a GPU, or other such processing unit. Once the data is present on the GPU, such as after the BVH is generated, tracing can be quite fast. Unfortunately, the time needed to build the BVH may take many times longer, such as at least five times longer than is needed for tracing. If there is anything in a scene that is moving or otherwise needs to be animated, the need to build and update such a BVH can significantly degrade performance. Another potential disadvantage of such an approach is that the scene size is limited by the amount of memory that is available for storage. It may therefore be difficult, or at least time and resource intensive, to attempt to trace highly detailed geometry.

Approaches in accordance with at least one embodiment attempt to avoid some of these and other such issues that may negatively impact performance. One such approach takes advantage of the fact that much of the geometry in a scene does not change significantly, if at all, between adjacent frames in a video sequence. For example, a given scene may contain many instances of static geometry, such as may include buildings, rocks, sidewalks, and other static geometry that will typically not move in a scene, More recent GPUs, such as Blackwell GPUs from NVIDIA Corporation, can split up a BVH and then stitch together prebuilt portions of the hierarchy that do not need to be rebuilt. A Blackwell-type GPU can build an acceleration structure for a small group of triangles and save that for reuse. The groups can then be stitched together into more complicated hierarchies, where the stitching can be quite fast due in part to optimizations that can be made on these groupings of triangles. Certain processing units may also have certain sizes for which they are optimized, such as where a GPU might be optimized to process exactly 128 or 256 triangles at a time, and having fewer triangles in a group may result in reduced performance or efficiency.

Various rendering approaches can treat these groupings or “clusters” of triangles (or other such faces) as individual graphics primitives. Such usage allows rendering algorithms to take advantage of the knowledge that the triangles within a given cluster are near each other in object space, and also likely have similar properties. FIG. 1 illustrates different triangle clusters 106 that each contain a non-overlapping set of triangles, where those triangles are all connected to at least one other triangle of the cluster 106 by at least one common edge and are relatively close to each other in object space (and also screen space after rendering). Examples of such rendering approaches include Nanite virtualized geometry technology in Unreal Engine 5 from Epic Games, as well as the NVIDIA Blackwell cluster acceleration structure feature from NVIDIA Corporation.

One challenge in such approaches involves a determination of how to optimally, or even advantageously, group these triangles into clusters. Random clustering, or clustering solely based on connectivity, can result in suboptimal clusters, as well as wasted resources. For example, high connectivity within clusters may be desirable for tasks such as decimating triangle meshes, but additional post processing may be needed to reach, but not exceed, a specified number of items per cluster. Clusters generated based on connectivity may also be less than optimal for raytracing, as there is no specific optimization for tight bounding boxes. If triangles in a cluster were selected at random and distributed across a mesh, then the bounding boxes would substantially overlap and likely span almost the entirety of the mesh. During raytracing, the path of a ray would then likely intersect or hit most bounding boxes, resulting in testing a majority of the triangles in a mesh for each ray. Having smaller and/or tighter bounding boxes can help to significantly reduce the number of triangles to be tested when a ray is determined to intersect a given bounding box.

Approaches in accordance with various embodiments of the present disclosure provide for improved clustering of triangles, or other geometric components of a mesh representation. Such approaches can take into account various desirable properties when clustering mesh geometry. For example, in at least one embodiment it can be advantageous to identify clusters with a fixed size, or as close to a fixed size as possible. This can be beneficial at least because data structures are often fixed, and any less than the maximum number of triangles in a cluster can result in wasted space and underutilized hardware. Such approaches can provide support for various types of geometry, including triangles, quads, and even other clusters of geometry. In at least one embodiment, such an approach can attempt to minimize the size (e.g., volume) of a bounding box or bounding sphere about a cluster, to provide for a tight grouping in space. Such an approach can also attempt to minimize the overlap between adjacent cluster bounding boxes, which can be important for ray-tracing process that use bounding box-based acceleration structures. Similarly, minimizing connectivity within individual clusters can be beneficial for tasks such as mesh simplification in level of detail (LOD) generation, among other such options.

Approaches in accordance with at least one embodiment can use a clustering algorithm that builds on top-down bounding volume hierarchy (BVH) construction. This can include, for example, the recursive splitting of a space based on one or more splitting criteria. When building a top-down structure, for example, items can be sorted along each of three axes, such as x, y, and z, and then an appropriate splitting position for one axis identified. These sortings can be stored and maintained to both represent the items in each node and their sorted order within nodes for each axis. These can be referred to as “sorted item arrays”, despite sorting only remaining valid within node ranges. These items may be sorted based on, for example, the locations of the centroids of those items along each axis. Some of the items will then be on a first side of the split and the remaining items will be on the other side of the split for a given axis, although in some instances some of the items may cross the split and thus have portions on both sides. For clustering, it is commonly desirable to have a single cluster membership per item, in which, for example, items are partitioned on either one or the other side based on their centroid position. For convenience these sides of a split will be referred to as “left” and “right” sides as many examples will be discussed with respect to 2D figures, but it should be understood that such usage is not a requirement or limitation on directionality or orientation of a split plane or other such feature. The node item sortings for each axis can be maintained after splitting a node by partitioning its items in other axes, perpendicular to the split, by whether each item is located in a first or second direction with respect to the split (e.g., to the left or the right of the split plane). The items on each of these sides can then be split again and again, recursively, until the groupings contain at most a target or maximum number of items, or another such splitting criterion is satisfied. Various approaches can be used to determine the locations of these various split planes. For example, a surface area heuristic can be used that attempts to optimize for a bounding box around the items on a split side that has a low surface area relative to the number of items in that bounding box. A typical surface area heuristic has a form like a quadratic, for example, where the minimum value can represent the appropriate split location. In at least one embodiment, a cost for each split location can be determined based on the surface area of the bounding box versus the number of items in the box. An attempt can be made to determine the location with the minimum cost along all three axes.

Items can also be stored uniquely using a point such as a centroid of a given triangle or item. Such an approach can restrict the node split position to produce leaves of an exact size, and can form clusters from items in each leaf. A surface area heuristic (SAH) can be used to build BVHs, as well as to identify and select an optimal (or at least most appropriate) split position among the restricted set of candidates. Various SAHs are designed for tasks such as raytracing, and generating clusters in this way can be particularly beneficial when the resulting clusters are to be used for raytracing. In at least one embodiment, such benefit is obtained due in part to the fact that the bounding boxes will be optimized. Reducing the number of candidates will often also improve algorithm performance.

One example approach can attempt to cluster items with a given size Cₙ, such as to include 128 or 256 items in each cluster. Such an approach can start with an SAH-based top down BVH construction algorithm (similar to a sweep k-d tree algorithm for points) that partitions items uniquely, rather than duplicating items that cross a split plane to both split blocks (or “children”). The inputs can comprise item bounding boxes and item or bounding box centroids, for example, which may vary for different implementations. The input items initially form a single root node, which can be split recursively. An indirect item sorting for each dimension can be determined and maintained, which can help to further improve performance. When searching for a split position for any dimension, candidates can be excluded that are not a multiple of the number of the cluster size Cₙ from the left. Such a process can thus involve advancing Cₙ when iterating. Items are partitioned into left and right nodes and the process repeats, terminating whenever n items per node satisfies n≤Cₙ, or where the number of items per node is equal or smaller than the cluster size, to account for a remainder edge case. Clusters can be trivially formed by the items in each remaining node. These would be the leaf nodes for a BVH or k-d tree algorithm. There would be at most one cluster (or leaf node) with less than Cₙ items, with all other clusters having the target cluster size Cₙ. Such an approach to cluster generation can be significant on downstream processing such as raytracing or other light transport simulation techniques.

In at least one embodiment, there may be fewer than the target number of items per leaf. This can include, for example, relaxing the original constraint of having exactly n=Cₙ items per cluster to a tunable range C_{A}≤n≤C_{B}, which gives the surface area heuristic more room to optimize the bounding boxes. In some embodiments, it may be beneficial to have a slightly better surface area heuristic value than an exact number of triangles in a cluster. There may be a minimum number of triangles to be included in a cluster, such as at least 120 triangles for a target size of 128, but the value for a given cluster may fall anywhere in that range if it better satisfies a target criterion. Iterative splitting can be performed, but where the number of items in the various leaf nodes need only fall within the target range. The optimal number of items in a cluster can depend upon various factors, such as the operation to be performed and/or the hardware to be used for the performance. The optimal number may also depend in part on the placement of the triangles, as it may be better to have 127 items in a cluster than to include a 128th item that is a significant distance away, and would thus result in a significantly larger bounding box and potentially many other triangles to be tested for several rays when raytracing or performing a similar operation. If raytracing is particularly fast for a given implementation, however, the bounding box size may not be particularly important, such that the range of items to be included in each cluster may be smaller or closer to the target size.

In at least one embodiment, relaxing of the original constraint can be given by:

$$\begin{matrix}( i ) mod {C}_{A} \leq ( {C}_{B} - {C}_{A} ) ⌊ \frac{i}{{C}_{A}} ⌋ \\ ( n - i ) mod {C}_{A} \leq ( {C}_{B} - {C}_{A} ) ⌊ \frac{n - i}{{C}_{A}} ⌋\end{matrix}$$

Where i is the number of items to the left of the split candidate. Other approaches than surface area heuristics can be used as well in other embodiments, but for implementations where surface area heuristics are already used in the hardware/software for BVH creation it can avoid excess complexity by taking advantage of such availability.

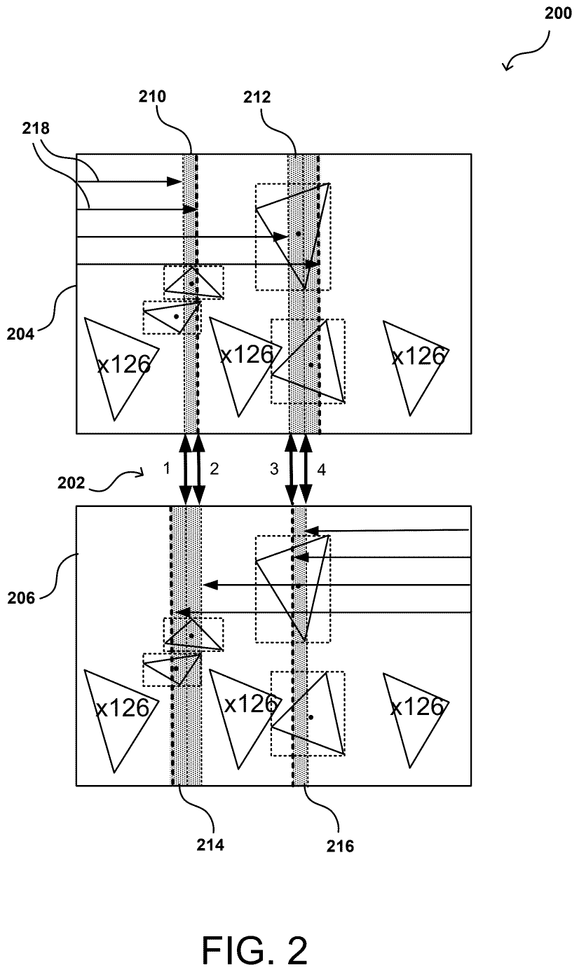

In FIG. 2, the vertical gray regions 210, 212, 214, 216 in the top view 204 and the bottom view 206 represent the regions in which it is acceptable to select a split plane. The locations of the regions differ based on the items in the left or right child nodes after splitting at each candidate position. The top view 204 considers left child node sizes and the bottom view 206 considers right child node sizes. Selecting a split plane outside these gray regions 210, 212, 214, 216 would result in a future split, during the recursive splitting process, ending up with a node having a number of elements outside the target range (e.g., 120-128). This example limits split candidates to those with acceptable left and right child node sizes after splitting (for all three axes) to attempt to determine the best split position within the node. In this example, as long as the selected split plane falls within the gray regions 210, 212, 214, 216, the number of items in the individual leaf nodes will satisfy the target size range or criterion. Arrows 218 in the figure represent the ranges of items in candidate child nodes, as well as the start and end of each range within which a split plane can optimally be positioned. In some situations it is possible that there may be no agreement in acceptable split position ranges between the left and right sweep directions, such that there may be no solution that satisfies the target criterion, in which case a selection algorithm may attempt to identify the split plane position that comes closest to the target criterion, or may select the best position from either the left or the right sweep direction, such that at least one of the nodes resulting from the split will satisfy the size criterion.

In prior approaches, the split would happen at i mod N=0, where i is the number of items in the left half. A split position satisfying the top equation above can help to ensure that leaf nodes in the left child will have item counts in the interval [C_{A} . . . C_{B}]. Similarly, the bottom equation above can provide a similar constraint for the right child. Considering only candidates satisfying both equations can result in leaves of the desired sizes. FIG. 2 illustrates an example situation 200 where there are four possible split candidates 202 for n in the interval [127 . . . 128]. As mentioned, such an approach can be spatial in nature, trying to group together triangles that are spatially close to each other but not necessarily connected. For example, it might be advantageous to cluster the triangles making up the fingertips on a hand, even though those fingertips are not (at least directly) connected. Relaxing the split positions allows for leaves of size 127 or 128. If the total number of items is small, it may not be possible to satisfy both equations. One solution, in such a situation, is to fall back to constraining the split position to just one equation for those nodes, where all but potentially one node will have n≥C_{A} items, with at most one leaf node having a number of items smaller than the target size, as given by n<C_{A}.

Such an approach can allow for a range of cluster sizes [C_{A} . . . C_{B}], but these values may all be preferred equally so the cost metric of the SAH algorithm can be used to make the decision. In at least one embodiment, this cost metric can be updated by adding an additional cost p to balance maximizing the number of items per cluster, as may be given by:

$$\begin{matrix}{p}_{left} = {C}_{B} ⌈ \frac{i}{{C}_{B}} ⌉ - i \\ {p}_{right} = {C}_{B} ⌈ \frac{n - i}{{C}_{B}} ⌉ - ( n - i ) \\ p = k ( {p}_{left} + {p}_{r i g h t} )\end{matrix}$$

The derivation is adding a cost for under-filled clusters, as may be given by kΣ(C_{B}−n) for all leaf nodes, where k is a tunable constant. As leaf nodes are formed later in the algorithm, this can be approximated for larger nodes by computing p_{left} and p_{right}, the best case number of items missing from clusters in each child. These are equivalent to (−i)mod C_{B} and (i−n)mod C_{B} respectively. The cost equation above can be used to determine the final cost to add to the existing SAH cost, p. In some embodiments p_{left} and p_{right} can be scaled by the surface area of each child node's bounding box to match the combined cost unit type. Parameter k may also be a function of n to adjust the importance of earlier split positions in the hierarchy.

In some embodiments, the true underfill cost per leaf node may be non-linear and, in at least some instances, may be modelled with a transfer function ƒ:

$$p = k ( f ( {p}_{left} ) + f ( {p}_{right} ) )$$

An artificial example is ƒ(x)=x², where x is the number of missing items, which increases the cost super-linearly with higher numbers of missing items. This may be applied to the total missing item count as above. The transfer function may instead be applied to model a per-leaf cost that assumes an even distribution of missing items across child nodes with:

$$p = k ⌈ \frac{i}{{C}_{B}} ⌉ f ( \frac{{p}_{left}}{⌈ \frac{i}{{C}_{B}} ⌉} ) + k ⌈ \frac{n - i}{{C}_{B}} ⌉ f ( \frac{{p}_{right}}{⌈ \frac{n - i}{{C}_{B}} ⌉} )$$

While an SAH as disclosed herein can produce small bounding boxes, it may not optimize specifically for reduced overlap between adjacent nodes. Reduced overlap may be beneficial, as intersection testing may then need to inspect both nodes within a region of the overlap unnecessarily. In at least one embodiment, a solution can be used that involves the addition of a left/right bounding box overlap cost to the existing SAH cost metric. Similar to the SAH itself, this additional cost can correspond to the surface area of the overlap volume between the candidate node bounding boxes, multiplied by the number of items in the parent node n, matching SAH normalization as appropriate. This can include computing the intersection of the bounding boxes from the right half and the left half, and then adding a cost based on the surface area of that intersection volume. Some algorithms may divide by the surface area of the parent node, but this may be skipped due to cancelling. The overlap volume is then only between the two child nodes being considered for splitting, to simplify the problem space. The bounding box size is already minimized in at least one embodiment due in part to the splitting process used, as discussed above. It might be the case however, that it might be better to have a slightly bigger bounding box for at least one node if it results in a smaller overlap. The various cost terms can thus be weighted as appropriate in different embodiments, with the values of the weights being determined empirically or otherwise inferred.

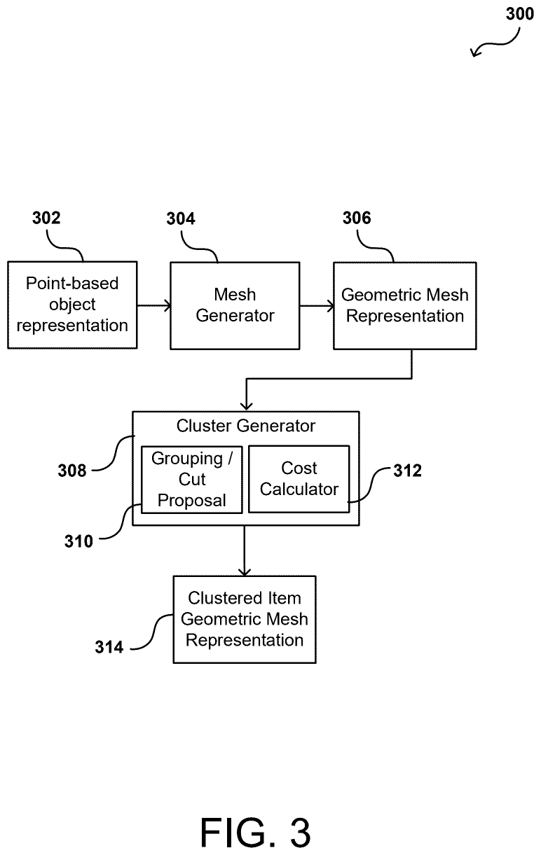

FIG. 3 illustrates components of an example system 300 that can be used to generate a mesh, including clustered items, according to at least one embodiment. In this example, input such as a point-based object representation 302 can be received, which can be provided as input to a mesh generator 304. The representation may include, for example, three-dimensional (3D) point cloud data captured by a LiDAR system with respect to a physical object, or other such representation. The mesh generator 304 can analyze the point-based object representation 302 to attempt to generate a geometric mesh representation of the object. This may include, for example, determining the appropriate pairs of vertices to be connected, where those connections define faces or geometric items that will comprise the mesh, and that approximate a surface shape of the object corresponding to the input representation. This may include, for example, generating a geometric mesh using a set of triangles as mesh items or faces. As mentioned, it can be beneficial for at least some downstream operations to group subsets of these triangles into a set of clusters. Accordingly, the generated mesh representation 306 can be provided as input to a cluster generator 308, although in some embodiments such a cluster generator may alternatively be part of the mesh generator 304. In this example system 300, the cluster generator 308 is a separate component as a mesh representation may be received as input that has already been generated, such that an additional generation step is not required.

In this example, the cluster generator 308 can include a grouping or cut position proposal algorithm 310 that can attempt to determine, for each iteration through the set of triangles of the mesh, potential cut positions or groupings that satisfy one or more criteria, as discussed herein. Generated proposals can then be sent to a cost calculator 312, which can use an appropriate cost formula to determine the cost for the individual proposals, with proposal being selected that produces a lowest cost (or satisfies another such selection criterion). As mentioned, the cost formula can include various terms that can be selected for different downstream operations, as may include costs for surface area, bounding box overlap, connectivity, and the like. The process can be performed iteratively until clusters are obtained that, except for at most one cluster, have a target number (or number within a given range as discussed subsequently herein) of elements in each cluster. Once such clusters are identified, a clustered item geometric mesh representation 314 can be produced, which can be provided to a downstream operation, pipeline, or process as input.

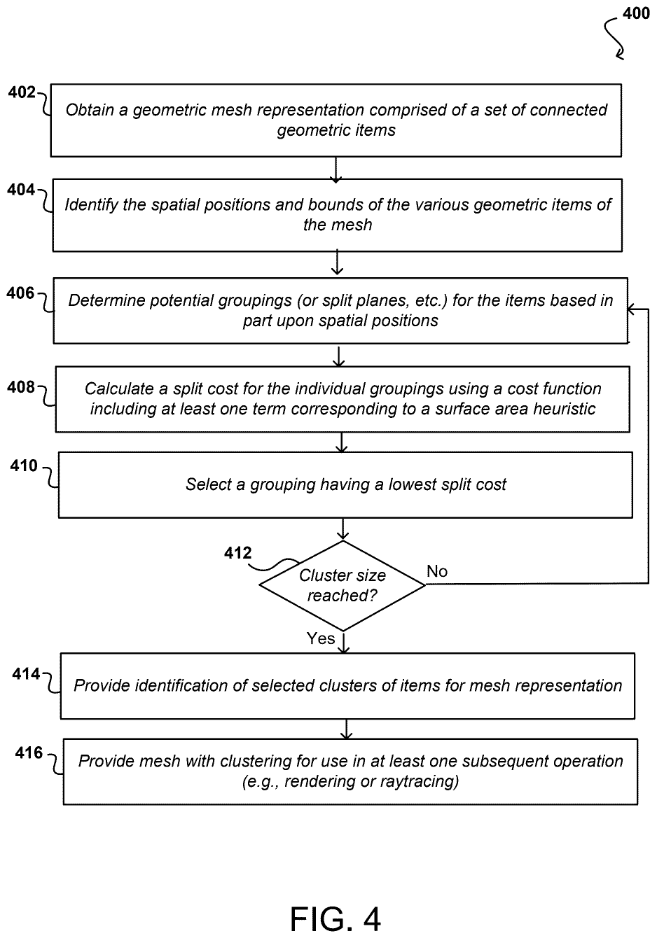

FIG. 4 illustrates an example process 400 that can be performed using such a system to determining a clustering to be used for a geometric mesh representation, according to at least one embodiment. It should be understood that for these and other processes presented herein there may be additional, fewer, or alternative steps performed in similar or alternative orders, or at least partially in parallel, within the scope of the various embodiments unless otherwise specifically stated. Further, although this example will be discussed with respect to use of a surface area heuristic, there can be other algorithms, heuristics, and approaches that can be used to calculate costs for various cut locations or item groupings as well within the scope of various embodiments. In this example process 400, a geometric mesh representation is obtained 402 that is comprised of a set of connected geometric items, such as triangular faces. The spatial positions and bounds of the various geometric items of the mesh can be identified 404. This may include, for example, determining the centroid locations for individual elements, as well as a bounding box or other such metric. Iterative grouping or splitting can be performed until clusters are obtained with a target number of items included, other than potentially at most one cluster for numbers of items that do not split evenly by target size. For a current iteration, potential groupings (or split planes or cut locations, etc.) can be determined 406 for the items based in part upon the spatial positions of the geometric items, among other such selection criteria as discussed and suggested herein. A split cost (or similar cost value) can be calculated 408 for each of these individual groupings (or at least a subset of the groupings) using a cost function that includes at least one term corresponding to a surface area heuristic, or similar such metric. A proposed grouping can then be selected 410 as the appropriate grouping for this iteration based, at least in part, upon the grouping associated with the lowest cut cost. If it is determined 412 that the iterative grouping has not yet resulted in clusters of the target size, such that at least one further iteration of grouping is needed, then the process can continue with another set of sub-groupings being proposed and costs determined. Once it is determined 412 that the target cluster size has been reached (for all but at most one cluster), then identification of the selected clusters of items (or the items in each cluster) can be provided 414 with respect to the mesh representation, such as a mapping of the global index values of the geometric items to a set of cluster identifiers. The mesh representation with the clustering information can then be provided 416 for use in at least one subsequent or downstream operation, such as may relate to rendering or raytracing, among other such operations.

In at least one embodiment, a further optimization can involve maximizing connectivity (or “adjacency”) within clusters. It is possible that an application may need, or at least benefit from, more control over how items are clustered, rather than just based on spatial locality. For example, triangles may share vertices and it may be beneficial to increase vertex reuse within a cluster. Sharing of vertices can be beneficial along shared borders when generating clusters, in particular for decimation and when generating levels of detail (LODs). For continuous LOD, the ability to prefer keeping “locked” edges and/or vertices internal to clusters when making clusters of clusters can also be important.

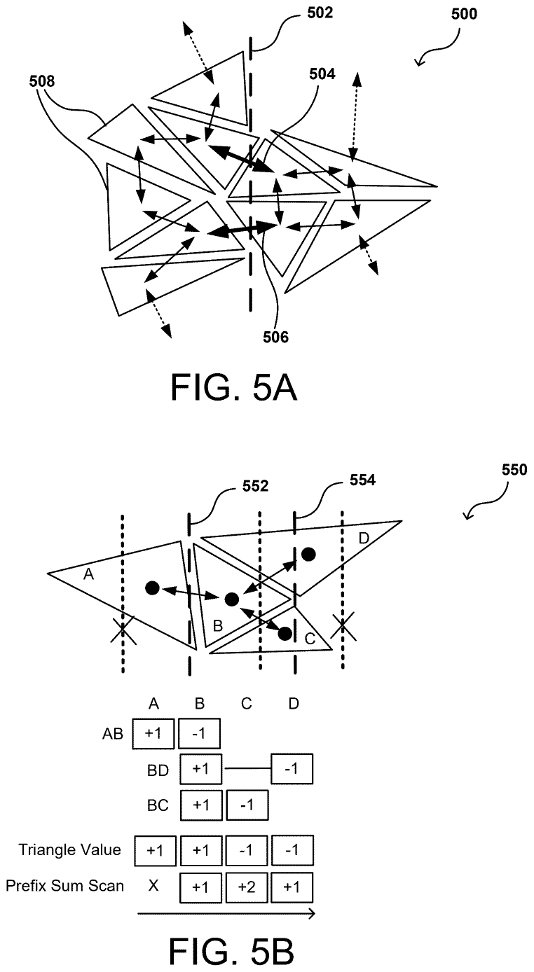

Approaches in accordance with at least one embodiment can use per-item connectivity and weights. Each item can have a list of zero or more connected items, as well as a numerical weight for each connection. The sum of weights of internal connections within each cluster can then be maximized or, equivalently, the sum of external connections minimized. FIG. 5A illustrates an example splitting approach 500 that can be used to find a “minimum cut” according to at least one embodiment. Such a process can be used to select a cut location for a set of triangles 508, where the connectivity is defined by shared edges. Each arrow in the figure represents a connection between two triangles along a shared edge, in the direction of the sharing (orthogonal to the edge at that location). This approach can differ from approaches targeting a shortest path or minimum spanning tree, where weight is often to be avoided. While such top-down recursive bisection approaches may not find an optimum, the quality of clusters produced can still be greatly improved by incorporating connectivity information and applying minimum cut cost optimizations even when only axis aligned splits are considered.

As mentioned, in some operations or use cases it can be beneficial to optimize for, or at least consider, adjacency and connectivity. An approach such as that disclosed with respect to FIG. 5A has the advantage of being able to account for connectivity while also providing variability in split plane location based, in part, upon the relevant costs. A connectivity term can be added to the cost function in order to reward solutions that favor connectivity, with the term being weighted as appropriate for a given operation or use case, etc. Such an approach has advantages for other situations as well, as a penalty can be applied to the cost if it is desired to reduce connectivity. As mentioned, the weights may be configurable, user provided, or determined empirically through experimentation, among other such options. Rather than focusing on connections to adjacent nodes, such an approach can consider the connections across the potential split plane location. The cost of connecting to adjacent nodes tends to cancel out, so it can be more important and/or beneficial to consider connections across the split plane, such as the connections 504, 506 illustrated in FIG. 5A. This consideration can be used together with a surface area heuristic and other approaches discussed herein to determine an optimal split plane location for a set of triangles or other geometric primitives. Normalization may be used for certain values as well where beneficial for computation and/or resource consumption.

In the example illustrated in FIG. 5A, the cut cost is the sum of connection weights crossing the split plane. In this example, the dotted line represents a cross-section of the split plane 502, with two connections 504, 506 between triangles being split by the selected split plane 502. An algorithm can be used to compute the cut cost that integrates with a top-down BVH construction algorithm. The cut cost for a split candidate after the ith item, cutᵢ, is the sum of weights of all connections bridging the split plane. The weights themselves can be used to provide a tunable balance with the SAH cost. Such a cut cost may grow proportionally to \sqrt{n} when connectivity represents a surface of n items in 3D space, and some embodiments may include a normalization term, dividing by \sqrt{n}. A further scaling by n and possibly the node's surface area may be used to convert the cut cost to SAH cost relative units.

One way to compute the cut cost is to attempt to find, for each item to the left of the candidate split, all connected items to the right of the candidate split. If such an item is found, the weight for that connection can be added to the cost. Performing such a search for each split candidate is redundant, however, and the search itself can be relatively slow even though the items are sorted. Approaches in accordance with at least one embodiment can efficiently compute the cut costs in each node. In at least one such approach, an array of size n is constructed that is filled with the sum of positive weights for connections to the right, and negative weights for connections to the left. Connections going outside the node can be ignored. The running total of this array, as may be computed with a prefix sum scan, can provide the split cost at each position. FIG. 5B illustrates an approach 550 to determining cut cost according to at least one embodiment. This approach can use a prefix sum scan of the rising-edge and falling-edge connection weights to obtain cut cost. The triangles will be considered left to right, with the positions determined using the centroids of the triangles, so in order from left to right the triangles in FIG. 5B are triangles A, B, C, and D. In this example there is a potential split plane location between each pair of centroids from left to right, as well as to the left and to the right of all centroids within a first (A) and last (D) triangle. Of the five potential split locations illustrated by the vertical lines in the FIG. 5B, the split locations to the left and to the right of all centroids would not result in a split (as all triangles would be to the left or to the right of the split position), so those split plane locations can be discarded, leaving the three potential split planes between the centroids of triangles A and D for consideration.

In this example, each connecting edge to the right can have a value of +1, and each connecting edge to the left can have a value of −1 (although other values or orientations could be used as well in other embodiments). For each of the connections between triangle centroids that would cross a split plane, there will be a pair of values, including +1 for the rising edge and −1 for the falling edge. An algorithm implementing the approach illustrated in FIG. 5B would, for every triangle, generate a list of edges or connections to other triangles (AB, BC, BD). Each connections can have a weight, but for simplicity it can be considered that these weights have values of 1 for all connections. In this example, triangles A, C, and D each have one outgoing connection under consideration, while triangle B has three outgoing connections under consideration. Such an approach can involve iterating through all these triangles to attempt to determine the sum of connections going to the right and the sum of connections going to the left. An array can then be generated that includes the rising and falling edges of costs, such that the array represents the changes in edge cut costs for a potential split position after each triangle centroid. Going from left to right, each connection when going to the right (a rising edge) increments the value by +1 in this example, and then when coming back to the left (a falling edge) decrements the value by −1. The sum total for each triangle can then be calculated based on the values for its connections, whether a rising or falling edge. For example, as illustrated, triangle B has one falling edge back to the left to triangle A for a value of −1, and two rising edge connections to triangles C and D, resulting in two values of +1, resulting in a final value for a split candidate after that triangle of +1, as illustrated in the top row of the bottom array. Triangles C and D each only have one falling edge connection back to triangle B, so those triangles each have a value of −1.

In this example, the values for each triangle can be determined and listed in the top row of the array. A prefix sum scan can then be performed using these values. Going from left to right, there will be no prior value to sum to the current value and the initial value of zero that would represent a split before triangle A is ignored. The first entry in the prefix sum scan row of the array has the value of triangle A, or +1—the cut cost for a cut before triangle B. The second value will be the sum of the triangle values for triangles A (+1) and B (+1), for a value of +2. The third value in the prefix sum scan row will be this most recent sum value (+2) plus the value of triangle C (−1), for a value of +1. The process will continue going from left to right until all connections for potential split plane locations have been considered. The process can then attempt to identify one or more cut positions with the lowest value. In this example, there are two split plane locations for which the prefix sum scan is +1, corresponding to the connection between triangles AB, and the connection between triangles BD. So, based on the cut cost, the split plane location should be at either of the identified location 552 or second location 554. Choosing between the two locations may depend in part upon at least one other value determined with respect to the split location determination process.

In at least some embodiments, however, it may not be straightforward to determine whether a given connection is “to the left,” “to the right,” or “external,” (among other such designations). It can also be at least somewhat inefficient to have to attempt to determine which side of a split (or which node) contains a given triangle of a set. For example, a search could be performed for all items in both nodes of a split to determine connections between triangles. If a connection to a given triangle, say X, is identified for a given triangle in one node, a search of all items in both nodes (and potentially other nodes) may need to be conducted to determine whether triangle X is in a specific node. Approaches in accordance with at least one embodiment can attempt to reduce the amount of searching and/or processing needed by generating one or more precomputed tables that allow for such information to be queried and located rather quickly.

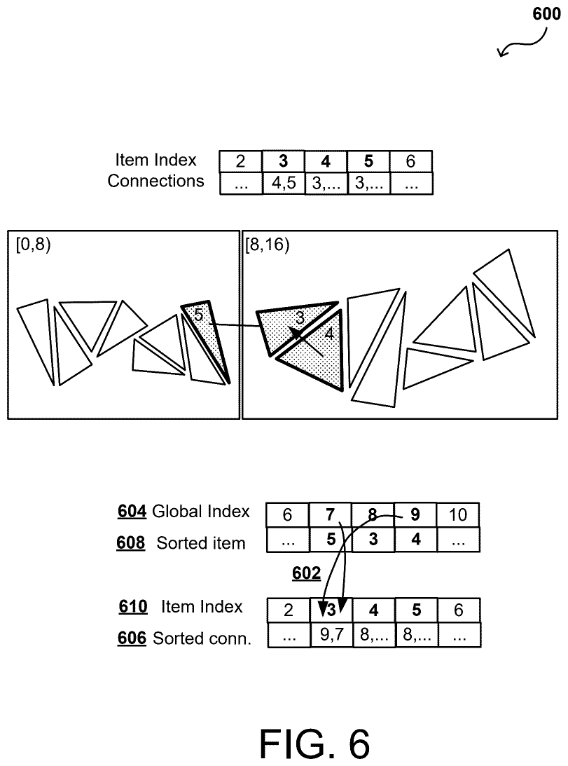

In at least one embodiment, connectivity tables can be reconstructed for each axis to contain indices into the sorted item arrays. These tables can be used to determine if a connected item is in the same node and in which direction in constant time. A scatter operation can be used to perform such reconstruction in at least one embodiment. Each item's index within the sorted item arrays can be added to the connections for that item in each axis. Since the weights can be stored in an equivalent array, this can either match the place of the returning connection or a new weight array generated. FIG. 6 illustrates an example approach 600 that can be used to build sorted-item-relative adjacency by scattering 602 a sorted index 604 to a returning connection table 606.

In this example, triangles are sorted along an axis based on their centroid position (or another such point or reference on the triangles). One axis is considered but this would happen for all axes. Triangles are grouped into two nodes of 8. A sorted index 604 is implied by the item's 608, or triangle's, position in the sorted item array. It is illustrated that triangle 3 at position 8 is connected to both triangles 4 and 5. In this example, it is desired to know whether those are in the same node and in which direction if so. With the sorted connections table 606 for each item 610, it can be determined (in constant time) that triangle 3's connections (triangles 4 and 5) are at sorted index 7 and 9 respectively. Sorted index 7 is outside triangle 3's node (8-15) and is thus external. Sorted index 9 is inside triangle 3's node and greater than position 8, so the connection becomes a rising edge for triangle 3.

The input to such an algorithm can therefore be a list of connections between triangles, such as a list of connecting indices (of input triangles) for each input triangle. An equivalent adjacency table can then be built from this input that instead stores indices to spatially sorted triangles for each axis after each iteration of splitting nodes. Such a table can be built relatively quickly and efficiently. When building a table, there will be two sets of connections between items. In at least one embodiment, even though connections are bi-directional, the input may need to explicitly list each of these connections twice to indicate each of the two directions (e.g., triangle A connecting to triangle B, and triangle B connecting to triangle A). As mentioned, a scatter approach can be used to determine the relationship between any two items in the set. As mentioned, there may be three different sorting, one for each axis, and the array can be rebuilt for each. Such an approach can help a pipeline that includes operations such as rendering or raytracing to run more efficiently.

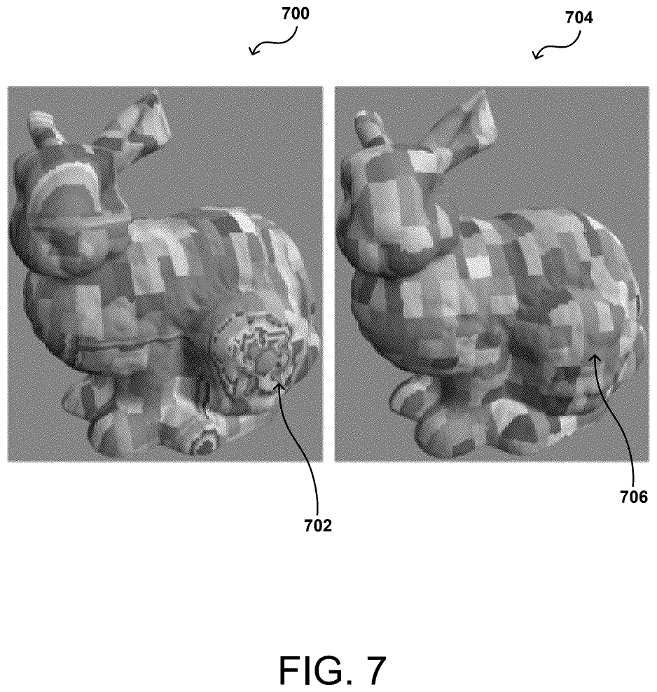

Another potential challenge in finding a minimum cut cost is that cutting the first and last items is often a trivial solution that gives degenerate results, such as those illustrated in the left image 702 of FIG. 7. Computing only minimum cut cost can often result in cut locations that cut off only one item, or a small number of items, rather than a more beneficial cut location. As illustrated, this may result in clusters in a region 702 that may be suboptimal, compared to beneficial clusters as illustrated for a similar region 706 in the right image 704 of FIG. 7. As illustrated, the clusters in the region 706 of the right image likely have higher connectivity and smaller bounding boxes, which can be beneficial for at least certain operations as discussed elsewhere herein.

Approaches in accordance with at least one embodiment can attempt to avoid these issues, or improve the cut location selection, by using one or more cut techniques. These can include, for example, a ratio cut and a normalize cut. A ratio cut can divide relevant costs by the number of items on either side of the proposed cut location. A normalize cost, on the other hand, can divide by the cumulative number of connections that each item has. These costs can then be summed with the surface area heuristic and other costs as discussed herein.

A ratio cut can be relatively straightforward to implement, scaling and replacing the cut cost cutᵢ, as may be given by:

$${cut}_{i} \cdot ( \frac{1}{i} + \frac{1}{n - i} )$$

Due to the ratio cut's normalization effect of dividing by item counts, some embodiments may restore the original cut cost scale by multiplying this result by n, including applying any other normalizations and unit conversions discussed earlier. For example, one embodiment may scale by n once to cancel ratio cut's normalization and again to match SAH units:

$${cut}_{i} \cdot ( \frac{1}{i} + \frac{1}{n - i} ) \cdot {n}^{2}$$

FIG. 7 illustrates in the right image 704 how use of a technique such as ratio cut avoids degenerate splits that might otherwise be present, as illustrated in the left image 700. Balancing weights with the SAH costs can further help avoid such degenerate splits.

A normalize cut approach is an alternative and may be given by:

$${cut}_{i} \cdot ( \frac{1}{{assoc}_{i}} + \frac{1}{{assoc}_{n} - {assoc}_{i}} )$$

Such an approach can use a running total degree (or “valency”) of each item, as may be given by:

$${assoc}_{i} = {\sum }_{j = 0}^{i - 1} {degree}_{j}$$

Such value can be computed with a pre-fix sum scan. Similarly to ratio cut, the result may further be scaled by n and any other normalizations and unit conversions discussed earlier applied.

Various use cases or operations can benefit from such approaches. For example, a speed of animation can be increased since certain positions in only certain clusters are being changed, and those clusters can be rebuilt more quickly than an entire mesh or BVH. A rendering process can also provide for a higher level (or variety of levels) of detail where there may be various clusters built, and at runtime a rendering process can choose which clusters to be stitched together into a larger BVH for tracing. For example, a rendering process might stitch together a set of high detail clusters and a set of low detail clusters, as may be appropriate for the location of those clusters in the scene (with clusters closer to a virtual camera benefitting from a higher level of detail).

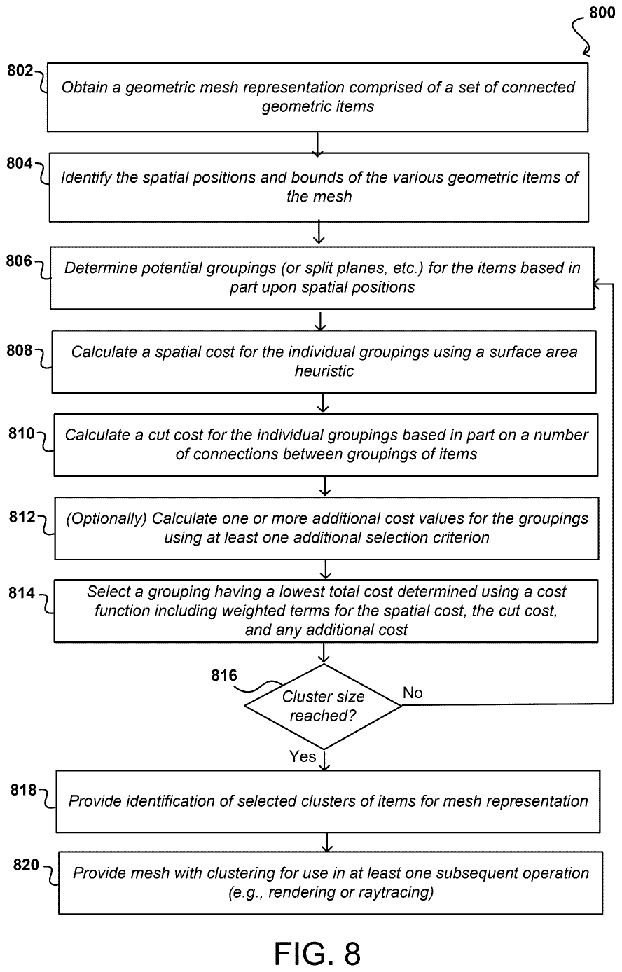

FIG. 8 illustrates an example process 800 that can be performed to consider at least connectivity and spatial position when determining a clustering to be used for a geometric mesh representation, according to at least one embodiment. In this example, a geometric mesh representation is obtained 802 (or generated, etc.) that is comprised of a set of connected geometric items, such as fully connected triangular faces. The spatial positions, and potentially the bounds, of the various geometric items of the mesh can be identified 804. In at least one embodiment, this can involve determining a centroid (or other such) position for each item, then sorting the items along one or more axes. Potential groupings of the items can then be determined 806 as may be based in part upon these spatial positions. As mentioned, there may be various criteria to be used to select an optimal grouping (or cut or split plane location) at each of a number of iterations, and each criterion can have a weighted term in an associated cost function. In this example, a “spatial” cost can be calculated 808 for the individual groupings, where the spatial cost may be calculated using a surface area heuristic (or other such algorithm) as discussed elsewhere herein. A “cut” cost can also be calculated 810 for the individual groupings at each iteration based in part on a number of connections between groupings of items, or within each grouping, such as to attempt to reward connections within a grouping or penalize external connections between groupings. There may be one or more additional cost values calculated 812 for one or more additional selection criteria, as may be based on bounding box overlap, cumulative connections, and the like. For each iteration, one of the proposed groupings can be selected 814 that, in this example, has a lowest overall cost determined using a cost function that includes weighted terms for the spatial cost, the cut cost, and any additional cost to be considered. The weights to be used for the various terms may be configurable, user provided, dependent on a downstream application, or determined from experimentation, among other such options.

If it is determined 816 that the iterative grouping has not yet resulted in clusters of the target size, such that at least one further iteration of grouping is needed, then the process can continue with another set of sub-groupings being proposed and costs determined. Once it is determined 816 that no cluster or grouping is above the target size (at most one cluster or grouping may be below the target size), then identification of the selected clusters of items (or the items in each cluster) can be provided 818 with respect to the mesh representation. For example, this may take the form of a mapping of the global index values of the geometric items to a set of cluster identifiers or linearized lists of global index values for each cluster. The mesh representation with the clustering information can then be provided 820 for use in at least one subsequent or downstream operation, such as may relate to rendering or raytracing, among other such operations.

As mentioned, such approaches can provide the flexibility to perform different types of clustering that take into account different factors, or different weightings of factors, as may be beneficial to various different use cases. To demonstrate cost unit conversion and some benefits of fixed sized clusters, consider this example of computing the cost for splitting a node with 1000 items at position 700, with a target size of 128 triangles per cluster. A first (e.g., left) side of a split could have 5 full clusters totaling 640 triangles with 60 remaining. A second (e.g., right) side would then have 2 full clusters with 44 triangles remaining. It could be assumed that the process will further split these nodes evenly or create minimum-size clusters to deal with the remaining triangles. Going with the former means the left would have 6 clusters of 700/6=116.6 triangles, or 6×≈11.3 missing triangles. The right would have 3 clusters with 28 missing triangles each. The underfill metric can generally be based off 6×11.3+3× 28=151.8 total missing triangles from all clusters. Some example implications of this and rationale for cost unit conversions are as follows.

In an example use case that involves allocating space for full clusters and not using all the memory, this could result in an estimated 151.8 triangles of wasted memory would clustering complete evenly. At 16 bytes per triangle, for example, that is a cost of ˜2.4 kb of memory. It is possible that saving an amount, such as 1 kb, of memory is worth spending 10 raytracing intersection tests per bounding box surface area at runtime (units of SAH). In practice the clusters can be further split before ray tracing so these conversions are an oversimplification. Nevertheless, a cost of 2.4×10=24 can then be added to the SAH cost for splitting the node at position 700, in a purely linear relationship.

In an embodiment that is going to build cluster acceleration structures for all clusters, it may be beneficial to schedule a thread for every triangle in each cluster. This might end up scheduling 151.8/1000 threads, or 1.2 clusters worth, with no data to operate on. The build performance could then be running at around 85% throughput, but in practice this may not be disadvantageous since the system may not fetch any memory for the missing triangles. If a cluster acceleration structure takes 60 microseconds to build and it is worth spending 1 SAH unit to save 100 microseconds, then 1.2×(100/60)=2 can be added to the cost for splitting the node at position 700.

The cluster acceleration structure may be inefficient if it only has a single triangle in it, such as may be equivalent to 100 SAH units. Once above some threshold, it may not make any difference at all and it could be closer to zero SAH units. This is where measuring might become particularly beneficial. An algorithm implementation could then provide some arguments for a cost transfer function approximation (e.g. linear/step function, polynomial, logarithmic, and/or exponential constants). It has been observed that there is a non-linear relationship between cluster size and cluster acceleration structure build performance.

Various embodiments take into account an SAH cost. This is not a requirement, however, and the value of an SAH cost has been observed to change for different node sizes. The surface area can be scene size dependent. Nodes at the top of a tree will generally be bigger and contain more items, arbitrarily driving up all SAH costs. These could be normalized, but it may not make much practical difference as long as some conversion takes place when mixing costs of different units.

Along these lines, one thing that might play a role in at least some implementations is that the edge cut cost will scale with the number of edges cut. However the SAH cost typically scales with the number of items. Since the number of cut edges is a slice of a surface formed by items (at least when items are triangles), this value may be broadly proportional to the square root of the total items in the node. This may be similar to the difference in slicing a grid or the perimeter of a sphere-plane intersection versus the surface area of the sphere. If no normalization were to be performed, the edge cut cost would be negligible in the larger nodes relative to smaller nodes. This can lead to use of a value such as cutᵢ n/\sqrt{n}=cutᵢ \sqrt{n} to stabilize the conversion to the SAH metric. It can be noted that other normalizations—such as for ratio cut, discussed earlier—are not included in this equation.

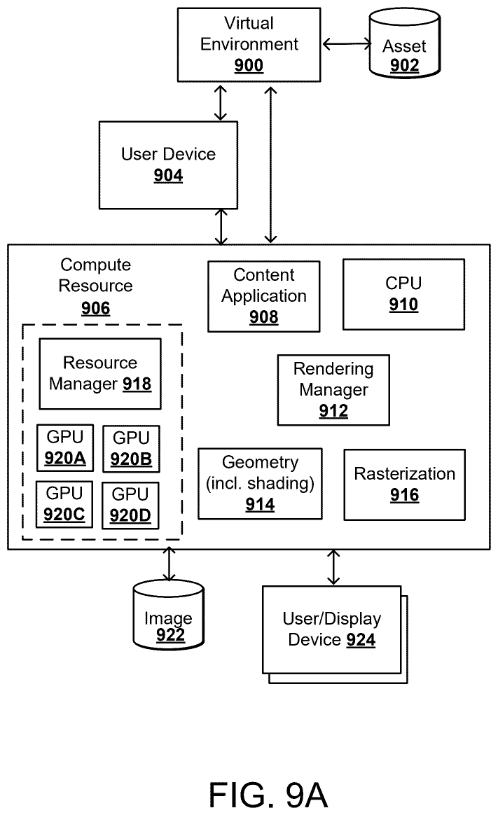

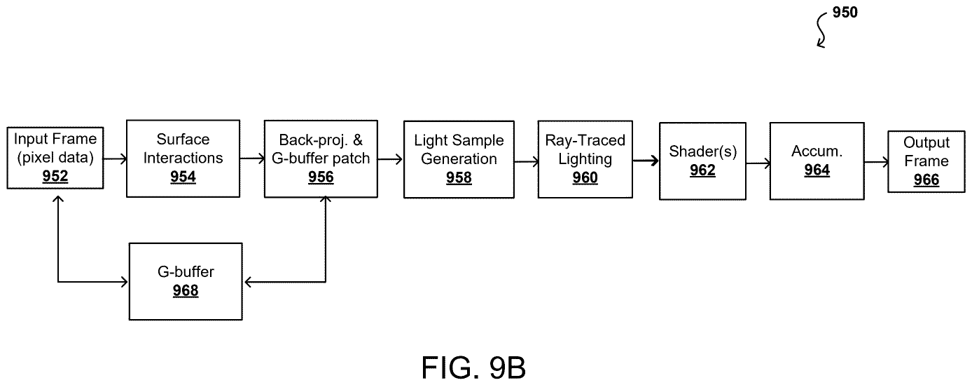

As mentioned, mesh representations with clusterings of geometric features can be used for tasks such as rendering of an image or video frame including a view of an object represented by the mesh. FIG. 9A illustrates an example system 900 for rendering such an image, video frame, or other instance of image-related content in accordance with at least one embodiment. Such a system can include or incorporate functionality as presented herein to allow for the consideration of a portion of the surface geometry of a model that has an unobstructed visual path to a camera-accessible region, among other such options. In this example, an image is to be rendered for a scene in a virtual environment 900, although images can be rendered for semi-virtual or real environments as well using such a system. The virtual environment 900 may include geometry and other data representative of shapes or objects in the environment, such as three-dimensional (3D) objects that are representative, or are to be included in, a scene that occurs within the environment, as may include foreground objects such as people or vehicles, or background objects such as roads and buildings, among other such options. In at least some embodiments, at least some of the content for the scene may also be obtained from an asset repository 902, or other such location, which can contain content—such as geometry, textures, and density data—that can be used to render the scene. In at least some embodiments or instances, there can be a user device 904 running a content generation or management application that can allow a user to select assets 902 and at least a relevant portion of the virtual environment 900 to use in rendering the scene. The user device 904 can also allow a user to control aspects of the image to be rendered, such as the location or pose of an object in the scene, as well as a viewpoint and other parameters of a virtual camera to be used to render an image of the virtual environment 900.

In this example, at least one compute resource 906 is used to perform the rendering. This resource may correspond to one or more servers, for example, that may be located locally or across at least one network, among other such options. In some embodiments, the rendering may instead be at least partially performed on the user device 904. The compute resource 906 may obtain or receive data to be used for the rendering, as may include geometry, texture, and density data for the virtual environment or assets, as well as information about the locations and poses of those objects in the scene and parameters of a virtual camera to be used to determine the view of the scene to be rendered. This information may be received to a content application 908, for example, that may be executing on a central processing unit (CPU) 910 of the compute resource that is responsible for tasks such as collecting data, causing an image to be rendered, and performing any formatting or encoding of a produced image, among other such operations. The content application can work with a rendering manager 912, for example, which can be responsible for coordinating operations of a rendering pipeline executing on the compute resource 906, as may include modules 914, 916 or processes responsible for tasks such as geometry related tasks (including lighting and shading tasks) and rasterization, among other such tasks. In at least one embodiment, a rendering manager 912 can generate a digital reconstruction of the virtual environment 900. In at least some embodiments, at least some of these rendering tasks may be performed using one or more GPUs 920A-D of the compute resource, as well as potentially one or more processors or compute instances (physical or virtual) of one or more other compute resources.

A task such as light transport simulation (e.g., ray tracing, path tracing, ray marching, etc.) or volumetric sampling can be performed using a single processor, such as a single GPU, or can have operations distributed across multiple GPUs 920A-D). In this example, there can be a pool or set of GPUs 920A-D, and a resource manager 918 can be at least partially responsible for allocating a GPU to perform the processing for an operation. If it is desired or beneficial to use more than one GPU then the resource manager 918 can allocate one or more GPUs having the appropriate capacity or capabilities. This can include allocating a number of GPUs indicated in a request, or determining a number of GPUs to allocate based in part on the request. In some embodiments, the resource manager may also be able to monitor an available bandwidth or memory in order to determine which and how many GPUs to allocate, such as where having high bandwidth capacity can allow operations to be spread across a greater number of GPUs, where bandwidth impact due to forwarding ray information will not be as critical, while having a bandwidth constrained system may cause the resource manager to attempt to allocate as few GPUs as possible in order to attempt to reduce the number of forwarding messages required.

In at least one embodiment, a partitioning of data can be performed by a rendering manager 912, for example, and the assigning of data to different processors can be performed by a resource manager 918 of the system. The resource manager can receive information from the rendering component, and can select appropriate processors from a pool of available processors 920 or processor capacity. In some embodiments, the rendering application can choose the partitioning, while in other embodiments the renderer may have no control over the data partitioning, which may be done by a separate management component (not illustrated in FIG. 9A). An image once rendered may be, for example, stored to an image repository 922 or provided for presentation via a user device and/or display device 924, among other such options.

FIG. 9B illustrates an example image generation pipeline 950 that can be used in a system 900—such as that illustrated in FIG. 9A—to render one or more images, such as video frames in a sequence for a specific scene and/or domain. In this example, pixel data 952 for a current frame to be rendered (as may include G-buffer data for primary surfaces) can be received as input to a reflections and refractions component 954 of a rendering system. Reflections and refractions component 954 can use this data to attempt to determine data for any determined reflections and/or refractions in the pixel data, and can provide this data to a back-projection and G-buffer patching component 956, which can perform back-propagation as discussed herein to locate corresponding points for those reflections and refractions, and use this data to patch the G-buffer 968, which can provide updated input for a subsequent frame to be rendered. The data can then be provided to a light sample generation component 958 to perform light sampling, a ray-traced lighting component 960 to perform ray-traced lighting, and one or more shaders 962, which can set the pixel colors for the various pixels of the frame based at least in part upon the determined lighting information (along with other information such as color, texture, and so on). The results can be accumulated by an accumulation module 964 or component for generating an output frame 966 of a desired size, resolution, or format.

In at least one embodiment, a shader 962 can perform the backward projection step. Once a backward projection pass has finished, and gradient surface parameters have been patched into the current G-buffer, a renderer can execute the lighting passes. Using information from the lighting passes and the lighting results from the previous frame, gradients can be computed then filtered and used for history rejection. Such an approach can be used to compute robust temporal gradients between current and previous frames in a temporal denoiser for ray traced renderers. Such a backward projection-based approach can also work through reflections and refractions, and can work with rasterized G-buffers. Previous approaches for backward projection omitted any G-buffer patching and relied on the raw current G-buffer samples instead, which also results in false positive gradients. Patching the surface parameters can eliminate false positives in the vast majority of cases, making the denoised image very stable yet still quickly reacting to lighting changes. Once the backward projection pass is finished, and gradient surface parameters have been patched into the current G-buffer, a renderer can execute the lighting passes. Using the information from the lighting passes and the lighting results from the previous frame, the gradients are computed then filtered and used for history rejection. NeRFs or other machine learning models can be used at various stages of such a pipeline, for use in inferring aspects of the rendering process.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server 1020 or third party service 1060, among other such options. In some instances, at least a portion of the processing, generation, compositing, and/or determination of this content may be performed by one of these other devices, systems, or entities, then provided to the client device (or another such recipient) for presentation or another such use.

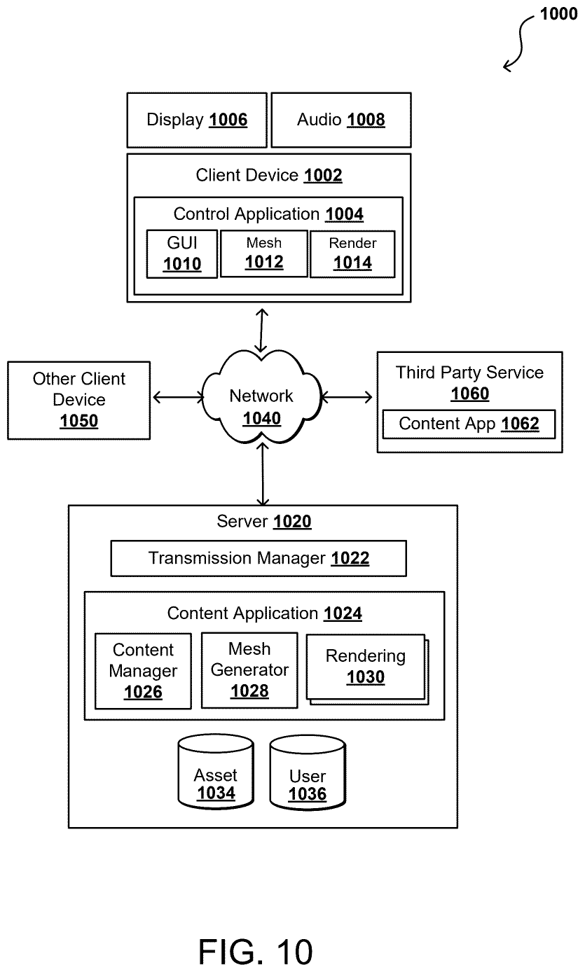

As an example, FIG. 10 illustrates an example network configuration 1000 that can be used to provide, generate, modify, encode, process, and/or transmit image data or other such content. In at least one embodiment, a client device 1002 can generate or receive data for a session using components of a content application 1004 on client device 1002 and data stored locally on that client device. In at least one embodiment, a content application 1024 executing on a server 1020 (e.g., a cloud server or edge server) may initiate a session associated with at least one client device 1002, as may utilize a session manager and user data stored in a user database 1036, and can cause content such as one or more digital assets (e.g., implicit and/or explicit object representations, such as models or meshes) from an asset repository 1034 to be determined by a content manager 1026. A content manager 1026 may work with a rendering module 1030 to generate or select objects, digital assets, or other such content to be represented in an image to be rendered. Views of these objects can be rendered by the rendering module 1030 and provided for presentation via the client device 1002. In this example, the content application 1024 includes a mesh generator 1028 that can generate mesh representations of objects using point cloud or other such object data, which can be provided to a rendering module 1030 in order to render a view of a digital object. In at least one embodiment, the content application 1024 can work with one or more encoders, transcoders, and/or compressors that can perform tasks such as encoding, decoding, compression, and/or decompression of a texture, image, or other such asset or instance of content, where different compressions or encodings may be beneficial for different operations, such as for storage versus processing. At least a portion of the rendered and/or compressed content may be transmitted to the client device 1002 using an appropriate transmission manager 1022 to send by download, streaming, or another such transmission channel. An encoder may be used to encode and/or compress at least some of this data before transmitting to the client device 1002. In at least one embodiment, the client device 1002 receiving such content can provide this content to a corresponding content application 1004, which may also or alternatively include a graphical user interface 1010, mesh generator 1012, and rendering module 1014 for use in providing, synthesizing, rendering, compositing, modifying, or using content for presentation (or other purposes) on or by the client device 1002. A decoder may also be used to decode data received over the network(s) 1040 for presentation via client device 1002, such as image or video content through a display 1006 and audio, such as sounds and music, through at least one audio playback device 1008, such as speakers or headphones. In at least one embodiment, at least some of this content may already be stored on, rendered on, or accessible to client device 1002 such that transmission over network 1040 is not required for at least that portion of content, such as where that content may have been previously downloaded or stored locally on a hard drive or optical disk. In at least one embodiment, a transmission mechanism such as data streaming can be used to transfer this content from server 1020, or user database 1036, to client device 1002. In at least one embodiment, at least a portion of this content can be obtained, enhanced, and/or streamed from another source, such as a third party service 1060 or other client device 1050, that may also include a content application 1062 for generating, enhancing, or providing content. In at least one embodiment, portions of this functionality can be performed using multiple computing devices, or multiple processors within one or more computing devices, such as may include a combination of CPUs and GPUs.

In at least one embodiment, components such as those illustrated in FIG. 10 can be used to offer aspects of various embodiments as one or more services, such as a Web service or cloud service, for example, that may be accessed using an appropriate API or address. Such a process may be relatively slow to perform, so having a streaming service process meshes in an asset pipeline (e.g. during game development) may be useful. This could happen once and the resulting clustering saved for distribution in a game, so the clustering algorithm is not directly part of the rendering, but something pre-computed.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

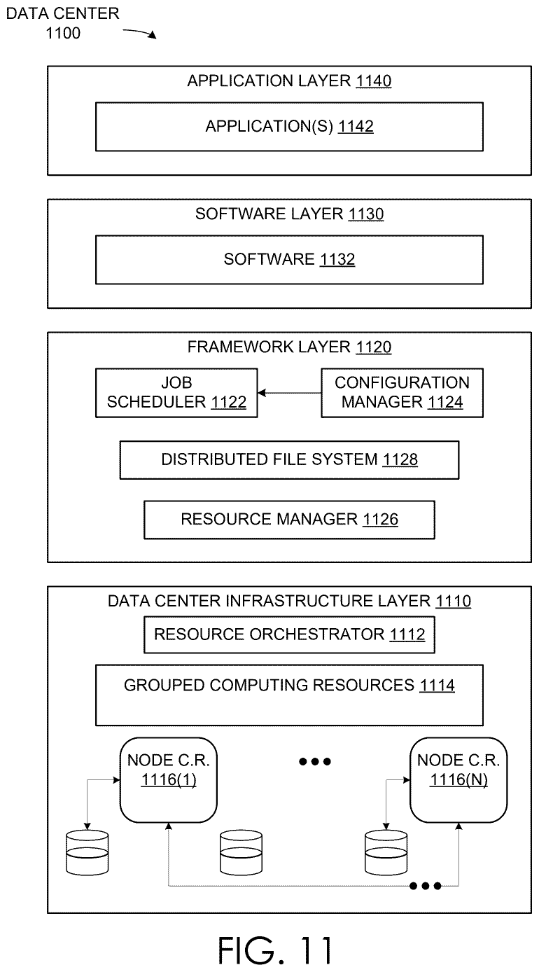

FIG. 11 illustrates an example data center 1100, in which at least one embodiment may be used. In at least one embodiment, data center 1100 includes a data center infrastructure layer 1110, a framework layer 1120, a software layer 1130, and an application layer 1140.

In at least one embodiment, as shown in FIG. 11, data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1116(1)-1116(N) may be a server having one or more of above-mentioned computing resources.

In at least one embodiment, grouped computing resources 1114 may include separate groupings of node C.R.s housed within one or more racks (not shown), or many racks housed in data centers at various geographical locations (also not shown). Separate groupings of node C.R.s within grouped computing resources 1114 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1112 may configure or otherwise control one or more node C.R.s 1116(1)-1116(N) and/or grouped computing resources 1114. In at least one embodiment, resource orchestrator 1112 may include a software design infrastructure (“SDI”) management entity for data center 1100. In at least one embodiment, resource orchestrator may include hardware, software or some combination thereof.

In at least one embodiment, as shown in FIG. 11, framework layer 1120 includes a job scheduler 1122, a configuration manager 1124, a resource manager 1126 and a distributed file system 1128. In at least one embodiment, framework layer 1120 may include a framework to support software 1132 of software layer 1130 and/or one or more application(s) 1142 of application layer 1140. In at least one embodiment, software 1132 or application(s) 1142 may respectively include web-based service software or applications, such as those provided by Amazon Web Services, Google Cloud and Microsoft Azure. In at least one embodiment, framework layer 1120 may be, but is not limited to, a type of free and open-source software web application framework such as Apache Spark™ (hereinafter “Spark”) that may use distributed file system 1128 for large-scale data processing (e.g., “big data”). In at least one embodiment, job scheduler 1122 may include a Spark driver to facilitate scheduling of workloads supported by various layers of data center 1100. In at least one embodiment, configuration manager 1124 may be capable of configuring different layers such as software layer 1130 and framework layer 1120 including Spark and distributed file system 1128 for supporting large-scale data processing. In at least one embodiment, resource manager 1126 may be capable of managing clustered or grouped computing resources mapped to or allocated for support of distributed file system 1128 and job scheduler 1122. In at least one embodiment, clustered or grouped computing resources may include grouped computing resource 1114 at data center infrastructure layer 1110. In at least one embodiment, resource manager 1126 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1128 of framework layer 1120. The one or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1128 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1124, resource manager 1126, and resource orchestrator 1112 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underused and/or poor performing portions of a data center.

In at least one embodiment, data center 1100 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1100. In at least one embodiment, trained machine learning models corresponding to one or more neural networks may be used to infer or predict information using resources described above with respect to data center 1100 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used to determine optimal clusterings of geometric items of a mesh representation for use with one or more subsequent operations.

### Computer Systems

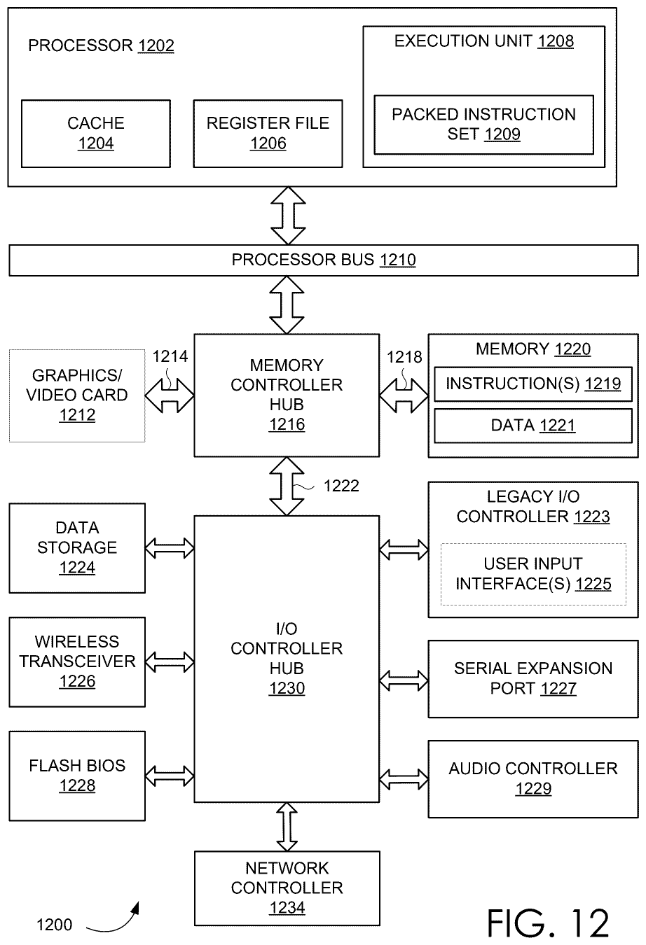

FIG. 12 is a block diagram illustrating an exemplary computer system, which may be a system with interconnected devices and components, a system-on-a-chip (SOC) or some combination thereof 1200 formed with a processor that may include execution units to execute an instruction, according to at least one embodiment. In at least one embodiment, computer system 1200 may include, without limitation, a component, such as a processor 1202 to employ execution units including logic to perform algorithms for process data, in accordance with present disclosure, such as in embodiment described herein. In at least one embodiment, computer system 1200 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1200 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 1200 may include, without limitation, processor 1202 that may include, without limitation, one or more execution units 1208 to perform machine learning model training and/or inferencing according to techniques described herein. In at least one embodiment, computer system 1200 is a single processor desktop or server system, but in another embodiment computer system 1200 may be a multiprocessor system. In at least one embodiment, processor 1202 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1202 may be coupled to a processor bus 1210 that may transmit data signals between processor 1202 and other components in computer system 1200.

In at least one embodiment, processor 1202 may include, without limitation, a Level 1 (“L1”) internal cache memory (“cache”) 1204. In at least one embodiment, processor 1202 may have a single internal cache or multiple levels of internal cache. In at least one embodiment, cache memory may reside external to processor 1202. Other embodiments may also include a combination of both internal and external caches depending on particular implementation and needs. In at least one embodiment, register file 1206 may store different types of data in various registers including, without limitation, integer registers, floating point registers, status registers, and instruction pointer register.

In at least one embodiment, execution unit 1208, including, without limitation, logic to perform integer and floating point operations, also resides in processor 1202. In at least one embodiment, processor 1202 may also include a microcode (“ucode”) read only memory (“ROM”) that stores microcode for certain macro instructions. In at least one embodiment, execution unit 1208 may include logic to handle a packed instruction set 1209. In at least one embodiment, by including packed instruction set 1209 in an instruction set of a general-purpose processor 1202, along with associated circuitry to execute instructions, operations used by many multimedia applications may be performed using packed data in a general-purpose processor 1202. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1208 may also be used in microcontrollers, embedded processors, graphics devices, DSPs, and other types of logic circuits. In at least one embodiment, computer system 1200 may include, without limitation, a memory 1220. In at least one embodiment, memory 1220 may be implemented as a Dynamic Random Access Memory (“DRAM”) device, a Static Random Access Memory (“SRAM”) device, flash memory device, or other memory device. In at least one embodiment, memory 1220 may store instruction(s) 1219 and/or data 1221 represented by data signals that may be executed by processor 1202.

In at least one embodiment, system logic chip may be coupled to processor bus 1210 and memory 1220. In at least one embodiment, system logic chip may include, without limitation, a memory controller hub (“MCH”) 1216, and processor 1202 may communicate with MCH 1216 via processor bus 1210. In at least one embodiment, MCH 1216 may provide a high bandwidth memory path 1218 to memory 1220 for instruction and data storage and for storage of graphics commands, data and textures. In at least one embodiment, MCH 1216 may direct data signals between processor 1202, memory 1220, and other components in computer system 1200 and to bridge data signals between processor bus 1210, memory 1220, and a system I/O 1222. In at least one embodiment, system logic chip may provide a graphics port for coupling to a graphics controller. In at least one embodiment, MCH 1216 may be coupled to memory 1220 through a high bandwidth memory path 1218 and graphics/video card 1212 may be coupled to MCH 1216 through an Accelerated Graphics Port (“AGP”) interconnect 1214.

In at least one embodiment, computer system 1200 may use system I/O 1222 that is a proprietary hub interface bus to couple MCH 1216 to I/O controller hub (“ICH”) 1230. In at least one embodiment, ICH 1230 may provide direct connections to some I/O devices via a local I/O bus. In at least one embodiment, local I/O bus may include, without limitation, a high-speed I/O bus for connecting peripherals to memory 1220, chipset, and processor 1202. Examples may include, without limitation, an audio controller 1229, a firmware hub (“flash BIOS”) 1228, a wireless transceiver 1226, a data storage 1224, a legacy I/O controller 1223 containing user input and keyboard interfaces 1225, a serial expansion port 1227, such as Universal Serial Bus (“USB”), and a network controller 1234. Data storage 1224 may comprise a hard disk drive, a floppy disk drive, a CD-ROM device, a flash memory device, or other mass storage device.

In at least one embodiment, FIG. 12 illustrates a system, which includes interconnected hardware devices or “chips”, whereas in other embodiments, FIG. 12 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1200 are interconnected using compute express link (CXL) interconnects.

Such components can be used to determine optimal clusterings of geometric items of a mesh representation for use with one or more subsequent operations.

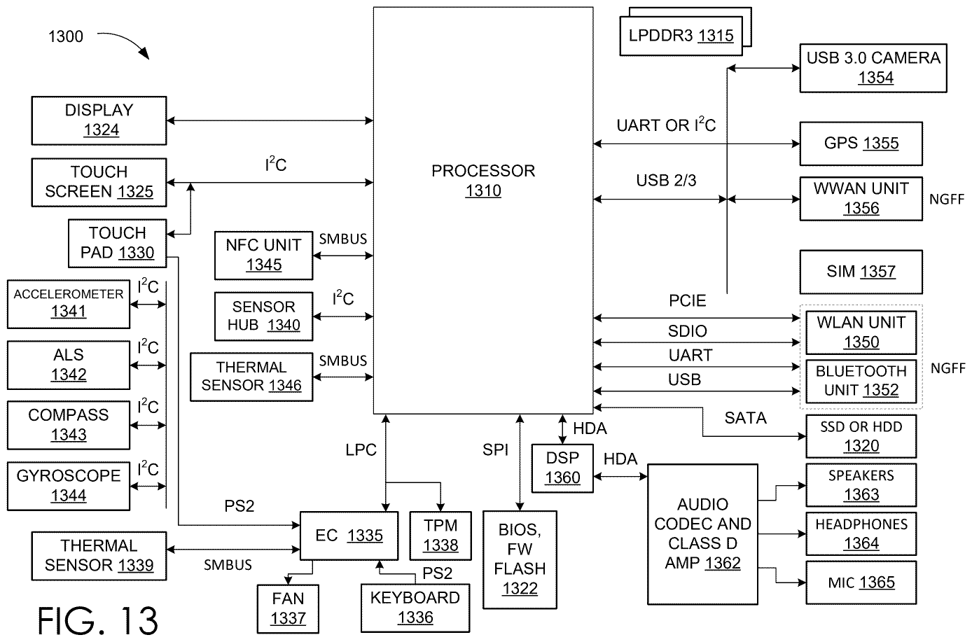

FIG. 13 is a block diagram illustrating an electronic device 1300 for utilizing a processor 1310, according to at least one embodiment. In at least one embodiment, electronic device 1300 may be, for example and without limitation, a notebook, a tower server, a rack server, a blade server, a laptop, a desktop, a tablet, a mobile device, a phone, an embedded computer, or any other suitable electronic device.

In at least one embodiment, system 1300 may include, without limitation, processor 1310 communicatively coupled to any suitable number or kind of components, peripherals, modules, or devices. In at least one embodiment, processor 1310 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 13 illustrates a system, which includes interconnected hardware devices or “chips”, whereas in other embodiments, FIG. 13 may illustrate an exemplary System on a Chip (“SoC”). In at least one embodiment, devices illustrated in FIG. 13 may be interconnected with proprietary interconnects, standardized interconnects (e.g., PCIe) or some combination thereof. In at least one embodiment, one or more components of FIG. 13 are interconnected using compute express link (CXL) interconnects.

In at least one embodiment, FIG. 13 may include a display 1324, a touch screen 1325, a touch pad 1330, a Near Field Communications unit (“NFC”) 1345, a sensor hub 1340, a thermal sensor 1346, an Express Chipset (“EC”) 1335, a Trusted Platform Module (“TPM”) 1338, BIOS/firmware/flash memory (“BIOS, FW Flash”) 1322, a DSP 1360, a drive 1320 such as a Solid State Disk (“SSD”) or a Hard Disk Drive (“HDD”), a wireless local area network unit (“WLAN”) 1350, a Bluetooth unit 1352, a Wireless Wide Area Network unit (“WWAN”) 1356, a Global Positioning System (GPS) 1355, a camera (“USB 3.0 camera”) 1354 such as a USB 3.0 camera, and/or a Low Power Double Data Rate (“LPDDR”) memory unit (“LPDDR3”) 1315 implemented in, for example, LPDDR3 standard. These components may each be implemented in any suitable manner.

In at least one embodiment, other components may be communicatively coupled to processor 1310 through components discussed above. In at least one embodiment, an accelerometer 1341, Ambient Light Sensor (“ALS”) 1342, compass 1343, and a gyroscope 1344 may be communicatively coupled to sensor hub 1340. In at least one embodiment, thermal sensor 1339, a fan 1337, a keyboard 1336, and a touch pad 1330 may be communicatively coupled to EC 1335. In at least one embodiment, speaker 1363, headphones 1364, and microphone (“mic”) 1365 may be communicatively coupled to an audio unit (“audio codec and class d amp”) 1362, which may in turn be communicatively coupled to DSP 1360. In at least one embodiment, audio unit 1362 may include, for example and without limitation, an audio coder/decoder (“codec”) and a class D amplifier. In at least one embodiment, SIM card (“SIM”) 1357 may be communicatively coupled to WWAN unit 1356. In at least one embodiment, components such as WLAN unit 1350 and Bluetooth unit 1352, as well as WWAN unit 1356 may be implemented in a Next Generation Form Factor (“NGFF”).

Such components can be used to determine optimal clusterings of geometric items of a mesh representation for use with one or more subsequent operations.

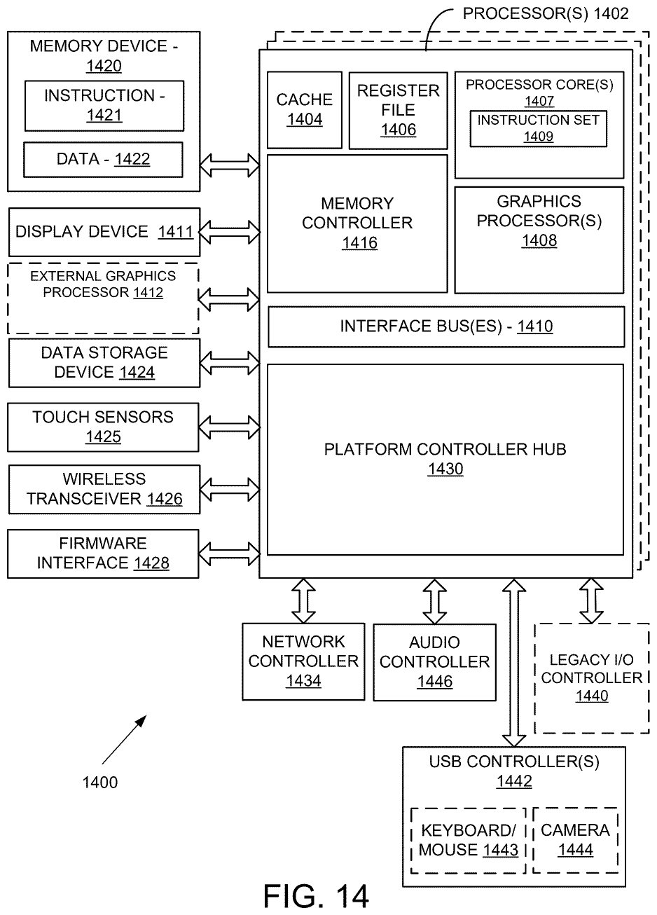

FIG. 14 is a block diagram of a processing system, according to at least one embodiment. In at least one embodiment, system 1400 includes one or more processors 1402 and one or more graphics processors 1408, and may be a single processor desktop system, a multiprocessor workstation system, or a server system having a large number of processors 1402 or processor cores 1407. In at least one embodiment, system 1400 is a processing platform incorporated within a system-on-a-chip (SoC) integrated circuit for use in mobile, handheld, or embedded devices.

In at least one embodiment, system 1400 can include, or be incorporated within a server-based gaming platform, a game console, including a game and media console, a mobile gaming console, a handheld game console, or an online game console. In at least one embodiment, system 1400 is a mobile phone, smart phone, tablet computing device or mobile Internet device. In at least one embodiment, processing system 1400 can also include, couple with, or be integrated within a wearable device, such as a smart watch wearable device, smart eyewear device, augmented reality device, or virtual reality device. In at least one embodiment, processing system 1400 is a television or set top box device having one or more processors 1402 and a graphical interface generated by one or more graphics processors 1408.

In at least one embodiment, one or more processors 1402 each include one or more processor cores 1407 to process instructions which, when executed, perform operations for system and user software. In at least one embodiment, each of one or more processor cores 1407 is configured to process a specific instruction set 1409. In at least one embodiment, instruction set 1409 may facilitate Complex Instruction Set Computing (CISC), Reduced Instruction Set Computing (RISC), or computing via a Very Long Instruction Word (VLIW). In at least one embodiment, processor cores 1407 may each process a different instruction set 1409, which may include instructions to facilitate emulation of other instruction sets. In at least one embodiment, processor core 1407 may also include other processing devices, such a Digital Signal Processor (DSP).

In at least one embodiment, processor 1402 includes cache memory 1404. In at least one embodiment, processor 1402 can have a single internal cache or multiple levels of internal cache. In at least one embodiment, cache memory is shared among various components of processor 1402. In at least one embodiment, processor 1402 also uses an external cache (e.g., a Level-3 (L3) cache or Last Level Cache (LLC)) (not shown), which may be shared among processor cores 1407 using known cache coherency techniques. In at least one embodiment, register file 1406 is additionally included in processor 1402 which may include different types of registers for storing different types of data (e.g., integer registers, floating point registers, status registers, and an instruction pointer register). In at least one embodiment, register file 1406 may include general-purpose registers or other registers.

In at least one embodiment, one or more processor(s) 1402 are coupled with one or more interface bus(es) 1410 to transmit communication signals such as address, data, or control signals between processor 1402 and other components in system 1400. In at least one embodiment, interface bus 1410, in one embodiment, can be a processor bus, such as a version of a Direct Media Interface (DMI) bus. In at least one embodiment, interface 1410 is not limited to a DMI bus, and may include one or more Peripheral Component Interconnect buses (e.g., PCI, PCI Express), memory busses, or other types of interface busses. In at least one embodiment processor(s) 1402 include an integrated memory controller 1416 and a platform controller hub 1430. In at least one embodiment, memory controller 1416 facilitates communication between a memory device and other components of system 1400, while platform controller hub (PCH) 1430 provides connections to I/O devices via a local I/O bus.

In at least one embodiment, memory device 1420 can be a dynamic random access memory (DRAM) device, a static random access memory (SRAM) device, flash memory device, phase-change memory device, or some other memory device having suitable performance to serve as process memory. In at least one embodiment memory device 1420 can operate as system memory for system 1400, to store data 1422 and instructions 1421 for use when one or more processors 1402 executes an application or process. In at least one embodiment, memory controller 1416 also couples with an optional external graphics processor 1412, which may communicate with one or more graphics processors 1408 in processors 1402 to perform graphics and media operations. In at least one embodiment, a display device 1411 can connect to processor(s) 1402. In at least one embodiment display device 1411 can include one or more of an internal display device, as in a mobile electronic device or a laptop device or an external display device attached via a display interface (e.g., DisplayPort, etc.). In at least one embodiment, display device 1411 can include a head mounted display (HMD) such as a stereoscopic display device for use in virtual reality (VR) applications or augmented reality (AR) applications.

In at least one embodiment, platform controller hub 1430 enables peripherals to connect to memory device 1420 and processor 1402 via a high-speed I/O bus. In at least one embodiment, I/O peripherals include, but are not limited to, an audio controller 1446, a network controller 1434, a firmware interface 1428, a wireless transceiver 1426, touch sensors 1425, a data storage device 1424 (e.g., hard disk drive, flash memory, etc.). In at least one embodiment, data storage device 1424 can connect via a storage interface (e.g., SATA) or via a peripheral bus, such as a Peripheral Component Interconnect bus (e.g., PCI, PCI Express). In at least one embodiment, touch sensors 1425 can include touch screen sensors, pressure sensors, or fingerprint sensors. In at least one embodiment, wireless transceiver 1426 can be a Wi-Fi transceiver, a Bluetooth transceiver, or a mobile network transceiver such as a 3G, 4G, or Long Term Evolution (LTE) transceiver. In at least one embodiment, firmware interface 1428 enables communication with system firmware, and can be, for example, a unified extensible firmware interface (UEFI). In at least one embodiment, network controller 1434 can enable a network connection to a wired network. In at least one embodiment, a high-performance network controller (not shown) couples with interface bus 1410. In at least one embodiment, audio controller 1446 is a multi-channel high definition audio controller. In at least one embodiment, system 1400 includes an optional legacy I/O controller 1440 for coupling legacy (e.g., Personal System 2 (PS/2)) devices to system. In at least one embodiment, platform controller hub 1430 can also connect to one or more Universal Serial Bus (USB) controllers 1442 connect input devices, such as keyboard and mouse 1443 combinations, a camera 1444, or other USB input devices.

In at least one embodiment, an instance of memory controller 1416 and platform controller hub 1430 may be integrated into a discreet external graphics processor, such as external graphics processor 1412. In at least one embodiment, platform controller hub 1430 and/or memory controller 1416 may be external to one or more processor(s) 1402. For example, in at least one embodiment, system 1400 can include an external memory controller 1416 and platform controller hub 1430, which may be configured as a memory controller hub and peripheral controller hub within a system chipset that is in communication with processor(s) 1402.

Such components can be used to determine optimal clusterings of geometric items of a mesh representation for use with one or more subsequent operations.

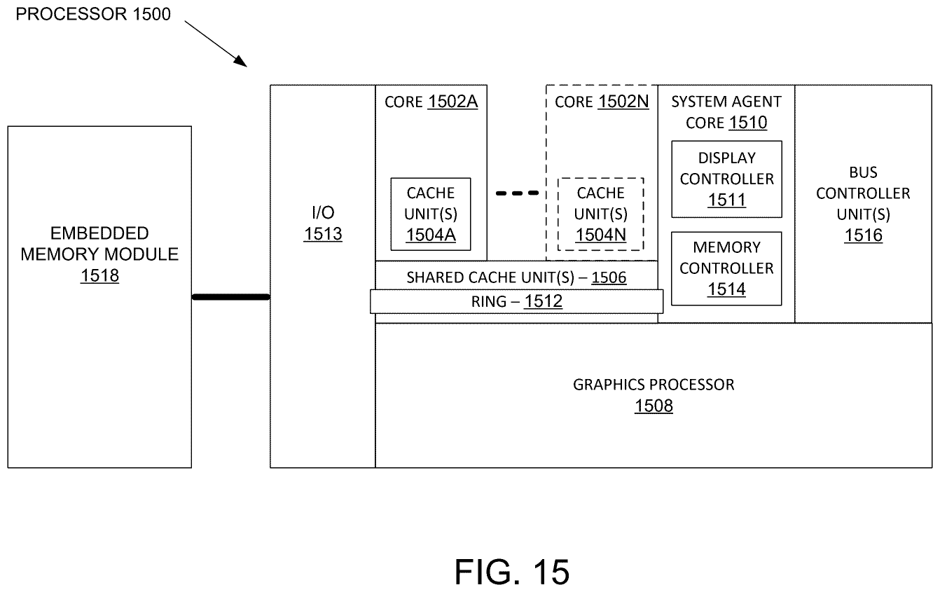

FIG. 15 is a block diagram of a processor 1500 having one or more processor cores 1502A-1502N, an integrated memory controller 1514, and an integrated graphics processor 1508, according to at least one embodiment. In at least one embodiment, processor 1500 can include additional cores up to and including additional core 1502N represented by dashed lined boxes. In at least one embodiment, each of processor cores 1502A-1502N includes one or more internal cache units 1504A-1504N. In at least one embodiment, each processor core also has access to one or more shared cached units 1506.

In at least one embodiment, internal cache units 1504A-1504N and shared cache units 1506 represent a cache memory hierarchy within processor 1500. In at least one embodiment, cache memory units 1504A-1504N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1506 and 1504A-1504N.

In at least one embodiment, processor 1500 may also include a set of one or more bus controller units 1516 and a system agent core 1510. In at least one embodiment, one or more bus controller units 1516 manage a set of peripheral buses, such as one or more PCI or PCI express busses. In at least one embodiment, system agent core 1510 provides management functionality for various processor components. In at least one embodiment, system agent core 1510 includes one or more integrated memory controllers 1514 to manage access to various external memory devices (not shown).

In at least one embodiment, one or more of processor cores 1502A-1502N include support for simultaneous multi-threading. In at least one embodiment, system agent core 1510 includes components for coordinating and operating cores 1502A-1502N during multi-threaded processing. In at least one embodiment, system agent core 1510 may additionally include a power control unit (PCU), which includes logic and components to regulate one or more power states of processor cores 1502A-1502N and graphics processor 1508.

In at least one embodiment, processor 1500 additionally includes graphics processor 1508 to execute graphics processing operations. In at least one embodiment, graphics processor 1508 couples with shared cache units 1506, and system agent core 1510, including one or more integrated memory controllers 1514. In at least one embodiment, system agent core 1510 also includes a display controller 1511 to drive graphics processor output to one or more coupled displays. In at least one embodiment, display controller 1511 may also be a separate module coupled with graphics processor 1508 via at least one interconnect, or may be integrated within graphics processor 1508.

In at least one embodiment, a ring based interconnect unit 1512 is used to couple internal components of processor 1500. In at least one embodiment, an alternative interconnect unit may be used, such as a point-to-point interconnect, a switched interconnect, or other techniques. In at least one embodiment, graphics processor 1508 couples with ring interconnect 1512 via an I/O link 1513.

In at least one embodiment, I/O link 1513 represents at least one of multiple varieties of I/O interconnects, including an on package I/O interconnect which facilitates communication between various processor components and a high-performance embedded memory module 1518, such as an eDRAM module. In at least one embodiment, each of processor cores 1502A-1502N and graphics processor 1508 use embedded memory modules 1518 as a shared Last Level Cache.

In at least one embodiment, processor cores 1502A-1502N are homogenous cores executing a common instruction set architecture. In at least one embodiment, processor cores 1502A-1502N are heterogeneous in terms of instruction set architecture (ISA), where one or more of processor cores 1502A-1502N execute a common instruction set, while one or more other cores of processor cores 1502A-1502N executes a subset of a common instruction set or a different instruction set. In at least one embodiment, processor cores 1502A-1502N are heterogeneous in terms of microarchitecture, where one or more cores having a relatively higher power consumption couple with one or more power cores having a lower power consumption. In at least one embodiment, processor 1500 can be implemented on one or more chips or as an SoC integrated circuit.

Such components can be used to determine optimal clusterings of geometric items of a mesh representation for use with one or more subsequent operations.

Various embodiments can be described by the following clauses:

1. At least one processor, comprising:
one or more processing units to:
identify spatial positions of a plurality of geometric primitives to be used to render an image of a scene;
determine, for each of a number of iterations, potential sub-groupings of the plurality of geometric primitives based in part on the spatial positions;
calculate, for each iteration, a spatial cost for each sub-grouping using a surface area heuristic;
calculate, for each iteration, a cut cost for each sub-grouping based in part on a number of connections between geometric primitives crossing between different groups, or within a same group, of a respective sub-grouping; and
provide, after a final iteration of the number of iterations, a set of final sub-groupings of the geometric primitives to be used to render the image, the set of final sub-groupings having a lowest cost calculated using at least the spatial cost and the connectivity cost.

2. The at least one processor of clause 1, wherein the one or more processing units are further to:
identify the connections between the geometric primitives crossing between different groups, or within the same group, each connected pair of geometric primitives having a first connection and a second connection in opposite directions.

3. The at least one processor of clause 2, wherein the one or more processing units are further to:
determine the cut cost using a spatially sorted array of primitive indices calculated using the first connection and the second connection identified for the connected pairs of geometric primitives.

4. The at least one processor of clause 2, wherein the one or more processing units are further to:
determine the cut cost at each of a plurality of potential cut positions for the potential sub-groupings using a prefix sum scan to produce a running total of a primitive array sorted by spatial position.

5. The at least one processor of clause 4, wherein the one or more processing units are further to:
determine the cut cost in part using a ratio cut to divide relevant costs by a number of items on each side of the potential cut positions.

6. The at least one processor of clause 4, wherein the one or more processing units are further to:
determine the cut cost in part using a normalize cut to consider a cumulative number of connections per geometric primitive.

7. The at least one processor of clause 4, wherein the one or more processing units are further to:
calculate, for each iteration, at least one additional cost for each sub-grouping based in part on at least one additional selection criterion; and
provide, after the final iteration of the number of iterations, the set of final sub-groupings of the geometric primitives to be used to render the image, the set of final sub-groupings having a lowest cost calculated using at least the spatial cost, the cut cost, and the at least one additional cost.

8. The at least one processor of clause 7, wherein the at least one additional cost includes at least one of a bounding box overlap cost or bounding box surface area cost for the geometric primitives in each group of the potential sub-groupings.

9. The at least one processor of clause 7, wherein the spatial cost and the connectivity cost are weighted by weights determined in part based on a subsequent operation to be performed using a mesh representation including the set of final sub-groupings of the geometric primitives.

10. The at least one processor of clause 1, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

11. A computer-implemented method, comprising:
determining, for each of a number of iterations, potential sub-groupings of a plurality of geometric primitives based in part on identified spatial positions;
calculating, for each iteration, a cut cost for each sub-grouping based in part on a number of connections between geometric primitives crossing between different groups, or within a same group, of a respective sub-grouping;
selecting, for each iteration, a sub-grouping with a lowest cost based at least in part on the cut cost; and
providing, after a final iteration of the number of iterations, a set of final sub-groupings of the geometric primitives to be used with one or more subsequent operations.

12. The computer-implemented method of clause 11, further comprising:
calculating, for each iteration, a spatial cost for each sub-grouping using a surface area heuristic, wherein the sub-grouping selected for each iteration is selected further based upon the spatial cost.

13. The computer-implemented method of clause 12, further comprising:
calculating, for each iteration, at least one additional cost for each sub-grouping based in part on at least one additional selection criterion; and
providing, after the final iteration of the number of iterations, the set of final sub-groupings of the geometric primitives, the set of final sub-groupings having a lowest cost calculated using at least the spatial cost, the cut cost, and the at least one additional cost.

14. The computer-implemented method of clause 11, further comprising:
calculating the cut cost using a spatially sorted array of primitive indices calculated using a first connection and a second connection identified for connected pairs of geometric primitives.

15. The computer-implemented method of clause 11, further comprising:
calculating the cut cost at each of a plurality of potential cut positions for the potential sub-groupings using a prefix sum scan to produce a running total of a primitive array sorted by spatial position.

16. The computer-implemented method of clause 11, further comprising:
calculating the cut cost in part using a ratio cut, to divide relevant costs by a number of items on each side of potential cut positions, or a normalize cut to consider a cumulative number of connections per geometric primitive.

17. A system, comprising:
one or more processing units to determine a set of clusters of geometric primitives to be used to perform light transport simulation for an image to be rendered, the clusters determined recursively by splitting the geometric primitives into smaller clusters based in part on spatial positions of the geometric primitives and connectivity of the geometric primitives between the clusters.

18. The system of clause 17, wherein the one or more processing units are further to recursively determine the clusters based in part on at least one additional splitting criterion, the clusters determined in part using a cost function including weighted terms for the spatial positions, the connectivity, and the at least one additional splitting criterion.

19. The system of clause 17, wherein the one or more processing units are further to calculate a cut cost for the clusters using a spatially sorted array of primitive indices calculated using connections identified for connected pairs of geometric primitives, or a plurality of potential cut positions for potential sub-groupings determined using a prefix sum scan to produce a running total of a primitive array sorted by spatial position.

20. The system of clause 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. At least one processor, comprising:
one or more processing units to:
identify spatial positions of a plurality of geometric primitives to be used to render an image of a scene;
determine, for each of a number of iterations, potential sub-groupings of the plurality of geometric primitives based in part on the spatial positions;
calculate, for each iteration, a spatial cost for each sub-grouping using a surface area heuristic;
calculate, for each iteration, a cut cost for each sub-grouping based in part on a number of connections between geometric primitives crossing between different groups, or within a same group, of a respective sub-grouping; and
provide, after a final iteration of the number of iterations, a set of final sub-groupings of the geometric primitives to be used to render the image, the set of final sub-groupings having a lowest cost calculated using at least the spatial cost and the connectivity cost.

2. The at least one processor of claim 1, wherein the one or more processing units are further to:
identify the connections between the geometric primitives crossing between different groups, or within the same group, each connected pair of geometric primitives having a first connection and a second connection in opposite directions.

3. The at least one processor of claim 2, wherein the one or more processing units are further to:
determine the cut cost using a spatially sorted array of primitive indices calculated using the first connection and the second connection identified for the connected pairs of geometric primitives.

4. The at least one processor of claim 2, wherein the one or more processing units are further to:
determine the cut cost at each of a plurality of potential cut positions for the potential sub-groupings using a prefix sum scan to produce a running total of a primitive array sorted by spatial position.

5. The at least one processor of claim 4, wherein the one or more processing units are further to:
determine the cut cost in part using a ratio cut to divide relevant costs by a number of items on each side of the potential cut positions.

6. The at least one processor of claim 4, wherein the one or more processing units are further to:
determine the cut cost in part using a normalize cut to consider a cumulative number of connections per geometric primitive.

7. The at least one processor of claim 4, wherein the one or more processing units are further to:
calculate, for each iteration, at least one additional cost for each sub-grouping based in part on at least one additional selection criterion; and
provide, after the final iteration of the number of iterations, the set of final sub-groupings of the geometric primitives to be used to render the image, the set of final sub-groupings having a lowest cost calculated using at least the spatial cost, the cut cost, and the at least one additional cost.

8. The at least one processor of claim 7, wherein the at least one additional cost includes at least one of a bounding box overlap cost or bounding box surface area cost for the geometric primitives in each group of the potential sub-groupings.

9. The at least one processor of claim 7, wherein the spatial cost and the connectivity cost are weighted by weights determined in part based on a subsequent operation to be performed using a mesh representation including the set of final sub-groupings of the geometric primitives.

10. The at least one processor of claim 1, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

11. A computer-implemented method, comprising:
determining, for each of a number of iterations, potential sub-groupings of a plurality of geometric primitives based in part on identified spatial positions;
calculating, for each iteration, a cut cost for each sub-grouping based in part on a number of connections between geometric primitives crossing between different groups, or within a same group, of a respective sub-grouping;
selecting, for each iteration, a sub-grouping with a lowest cost based at least in part on the cut cost; and
providing, after a final iteration of the number of iterations, a set of final sub-groupings of the geometric primitives to be used with one or more subsequent operations.

12. The computer-implemented method of claim 11, further comprising:
calculating, for each iteration, a spatial cost for each sub-grouping using a surface area heuristic, wherein the sub-grouping selected for each iteration is selected further based upon the spatial cost.

13. The computer-implemented method of claim 12, further comprising:
calculating, for each iteration, at least one additional cost for each sub-grouping based in part on at least one additional selection criterion; and
providing, after the final iteration of the number of iterations, the set of final sub-groupings of the geometric primitives, the set of final sub-groupings having a lowest cost calculated using at least the spatial cost, the cut cost, and the at least one additional cost.

14. The computer-implemented method of claim 11, further comprising:
calculating the cut cost using a spatially sorted array of primitive indices calculated using a first connection and a second connection identified for connected pairs of geometric primitives.

15. The computer-implemented method of claim 11, further comprising:
calculating the cut cost at each of a plurality of potential cut positions for the potential sub-groupings using a prefix sum scan to produce a running total of a primitive array sorted by spatial position.

16. The computer-implemented method of claim 11, further comprising:
calculating the cut cost in part using a ratio cut, to divide relevant costs by a number of items on each side of potential cut positions, or a normalize cut to consider a cumulative number of connections per geometric primitive.

17. A system, comprising:
one or more processing units to determine a set of clusters of geometric primitives to be used to perform light transport simulation for an image to be rendered, the clusters determined recursively by splitting the geometric primitives into smaller clusters based in part on spatial positions of the geometric primitives and connectivity of the geometric primitives between the clusters.

18. The system of claim 17, wherein the one or more processing units are further to recursively determine the clusters based in part on at least one additional splitting criterion, the clusters determined in part using a cost function including weighted terms for the spatial positions, the connectivity, and the at least one additional splitting criterion.

19. The system of claim 17, wherein the one or more processing units are further to calculate a cut cost for the clusters using a spatially sorted array of primitive indices calculated using connections identified for connected pairs of geometric primitives, or a plurality of potential cut positions for potential sub-groupings determined using a prefix sum scan to produce a running total of a primitive array sorted by spatial position.

20. The system of claim 17, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.
